(19) United States
(12) Patent Application Publication
(10) Pub. No.: US 2014/0355690 A1
(43) Pub. Date: Dec. 4, 2014

(54) METHOD AND APPARATUS FOR ENTROPY-ENCODING CAPABLE OF PARALLEL PROCESSING, AND METHOD AND APPARATUS FOR ENTROPY-DECODING CAPABLE OF PARALLEL PROCESSING

(71) Applicant: SAMSUNG ELECTRONICS CO., LTD., Suwon-si (KR)

(72) Inventors: Jong-bum Choi, Suwon-si (KR); Tammy Lee, Seoul (KR); Il-koo Kim, Osan-si (KR); Jeong-hoon Park, Seoul (KR); Jung-hye Min, Suwon-si (KR); Yinji Piao, Suwon-si (KR)

(73) Assignee: SAMSUNG ELECTRONICS CO., LTD., Suwon-si (KR)

(21) Appl. No.: 14/373,496

(22) PCT Filed: Jan. 21, 2013
(86) PCT No.: PCT/KR2013/000474

§ 371 Date: Jul. 21, 2014

Related U.S. Application Data
(60) Provisional application No. 61/588,691, filed on Jan. 20, 2012.

(51) Int. Cl. H04N 19/91; H04N 19/436; H04N 19/176

(52) U.S. Cl. CPC H04N 19/00951; H04N 19/00278; H04N 19/00521
USPC 375/240.24

(57) ABSTRACT

Provided is a method of performing parallel entropy encoding and parallel entropy decoding by using a plurality of processors. The method includes: sequentially performing entropy encoding on a first row of blocks from among blocks that each have a predetermined size and are obtained by splitting and encoding an image, determining initial entropy coding probability information of a foremost block of a second row of blocks as entropy coding probability information updated by a block of a fixed position of the first row of blocks, sequentially performing entropy encoding on blocks of the second row of blocks which are serially arranged based on the initial entropy coding probability information, and after the entropy encoding is completed to a last block of the first row of blocks, initializing internal state information of an entropy encoded bit string of the first row of blocks.

### TECHNICAL FIELD

The present invention relates to entropy encoding and entropy decoding for video encoding and decoding.

### BACKGROUND ART

As hardware for reproducing and storing high-resolution or high-quality video content has been developed and supplied, a need for a video codec for effectively encoding or decoding the high-resolution or high-quality video content has increased. According to a conventional video codec, a video is encoded according to a limited encoding method based on a macroblock having a predetermined size.

Image data of a spatial domain is transformed into coefficients of a frequency domain by using frequency transformation. A video codec splits an image into blocks each having a predetermined size in order to rapidly perform frequency transformation, performs DCT transformation on each of the blocks, and encodes frequency coefficients in units of the blocks. The coefficients of the frequency domain may be more easily compressed than the image data of the spatial domain. In particular, since an image pixel value of a spatial domain is expressed as a prediction error through inter prediction or intra prediction of a video codec, when frequency transformation is performed on the prediction error, a large amount of data may be transformed into zero (0). A video codec reduces the amount of data by replacing data which is continuously repeatedly generated with data with a data having a smaller size.

Entropy encoding is performed in order to compress a bit string of a symbol generated by video encoding. An arithmetic coding-based entropy encoding has recently been widely used. In order to perform arithmetic coding-based entropy encoding, symbols are digitized to a bit string and context-based arithmetic coding is performed on the bit string.

### DISCLOSURE OF THE INVENTION

### Technical Problem

The present invention provides a method of performing arithmetic coding-based entropy encoding and decoding for video encoding and decoding in a parallel manner by using a plurality of processors.

### Technical Solution

According to an aspect of the present invention, there is provided an entropy encoding method for video encoding, the entropy encoding method including: sequentially performing entropy encoding on blocks of a first row of blocks which serially arranged in a horizontal direction from among blocks that each have a predetermined size and are obtained by splitting and encoding an image; determining initial entropy coding probability information of a foremost block of a second row of blocks that are disposed under the first row of blocks to be adjacent to the first row of blocks as entropy coding probability information updated by a block of a fixed position of the first row of blocks, performing entropy encoding on the foremost block of the second row of blocks based on the determined initial entropy coding probability information, and sequentially performing entropy encoding on the serially arranged blocks of the second row of blocks; and after the entropy encoding is completed to a last block of the first row of blocks, initializing internal state information of an entropy encoded bit string of the first row of blocks.

### Advantageous Effects

An entropy encoding apparatus and an entropy decoding apparatus according to an embodiment of the present invention may simplify parallel entropy encoding and parallel entropy decoding and minimize performance degradation by determining a largest coding unit (LCU) that is to be referred to in order to determine initial code probability information of a foremost LCU for every row of LCUs at a closest fixed position and initializing internal state information of a buffer in a last LCU of the row of LCUs.

### BRIEF DESCRIPTION OF THE DRAWINGS

FIG. 1A is a block diagram illustrating an entropy encoding apparatus according to an embodiment of the present invention.

FIG. 1B is a flowchart illustrating an entropy encoding method performed by the entropy encoding apparatus of FIG. 1.

FIG. 2A is a block diagram illustrating an entropy decoding apparatus according to an embodiment of the present invention.

FIG. 2B is a flowchart illustrating an entropy decoding method performed by the entropy decoding apparatus of FIG. 2A.

FIG. 3 is a diagram for explaining a regular coding order and a wavefront coding order of blocks.

FIG. 4 is a diagram for explaining a wavefront coding order and a method of determining entropy coding probability information, according to an embodiment of the present invention.

FIGS. 5 and 6 are diagrams illustrating a relationship between a synchronization distance and a delay time of a subordinated thread.

FIG. 7 is a diagram for explaining a process of performing simplified parallel entropy encoding/decoding, according to an embodiment of the present invention.

FIG. 8 is a block diagram of a video encoding apparatus based on coding units according to a tree structure, according to an embodiment of the present invention.

FIG. 9 is a block diagram of a video decoding apparatus based on coding units according to a tree structure, according to an embodiment of the present invention.

FIG. 10 is a diagram for explaining a concept of coding units according to an embodiment of the present invention.

FIG. 11 is a block diagram of an image encoder based on coding units, according to an embodiment of the present invention.

FIG. 12 is a block diagram of an image decoder based on coding units, according to an embodiment of the present invention.

FIG. 13 is a diagram illustrating deeper coding units according to depths and partitions, according to an embodiment of the present invention.

FIG. 14 is a diagram for explaining a relationship between a coding unit and transformation units, according to an embodiment of the present invention.

FIG. 15 is a diagram for explaining encoding information of coding units corresponding to a coded depth, according to an embodiment of the present invention.

FIG. 16 is a diagram of deeper coding units according to depths, according to an embodiment of the present invention.

FIGS. 17 through 19 are diagrams for explaining a relationship between coding units, prediction units, and transformation units, according to an embodiment of the present invention.

FIG. 20 is a diagram for explaining a relationship between a coding unit, a prediction unit, and a transformation unit, according to encoding mode information of Table 1.

FIG. 21 is a diagram of a physical structure of a disc in which a program is stored, according to an embodiment of the present invention.

FIG. 22 is a diagram of a disc drive for recording and reading a program by using a disc.

FIG. 23 is a diagram of an overall structure of a content supply system for providing a content distribution service.

FIGS. 24 and 25 are diagrams respectively of an external structure and an internal structure of a mobile phone to which a video encoding method and a video decoding method are applied, according to an embodiment of the present invention.

FIG. 26 is a diagram of a digital broadcast system to which a communication system is applied, according to an embodiment of the present invention.

FIG. 27 is a diagram illustrating a network structure of a cloud computing system using a video encoding apparatus and a video decoding apparatus, according to an embodiment of the present invention.

### BEST MODE FOR CARRYING OUT THE INVENTION

An entropy encoding method for video encoding according to an embodiment of the present invention

According to an aspect of the present invention, there is provided an entropy encoding method for video encoding, the entropy encoding method including: sequentially performing entropy encoding on blocks of a first row of blocks which serially arranged in a horizontal direction from among blocks that each have a predetermined size and are obtained by splitting and encoding an image; determining initial entropy coding probability information of a foremost block of a second row of blocks that are disposed under the first row of blocks to be adjacent to the first row of blocks as entropy coding probability information updated by a block of a fixed position of the first row of blocks, performing entropy encoding on the foremost block of the second row of blocks based on the determined initial entropy coding probability information, and sequentially performing entropy encoding on the serially arranged blocks of the second row of blocks; and after the entropy encoding is completed to a last block of the first row of blocks, initializing internal state information of an entropy encoded bit string of the first row of blocks.

The sequentially performing of the entropy encoding on the serially arranged blocks of the second row of blocks may include: in order to determine initial entropy coding probability information of the foremost block of the second row of blocks, referring to entropy coding probability information updated by a second block of the first row of blocks which is located at a right upper side of the foremost block of the second row of blocks, and in order to determine a block which is to be referred to in order to determine the initial entropy coding probability information of the foremost block of the second row of blocks, skipping analyzing about when context synchronization between the first row of blocks and the second row of blocks occurs in a picture including the image.

The sequentially performing of the entropy encoding on the serially arranged blocks of the second row of blocks may include, after obtaining entropy coding probability information updated based on symbols of the second block of the first row of blocks, starting to perform entropy encoding beginning from the foremost block of the second row of blocks, wherein the entropy encoding method further includes, after obtaining entropy encoding probability information updated by a second block of the second row of blocks, starting to perform entropy encoding on a third row of blocks that are disposed under the second row of blocks to be adjacent to the second row of blocks beginning from a foremost block of the third row of blocks.

The initializing the internal state information of the entropy encoded bit string of the first row of blocks may include: in a buffer in which the entropy encoded bit string of the first row of blocks is stored, initializing to a default value offset information indicating a position where a code of the last block contacting a boundary of the image is stored and range information indicating a range of code intervals; and performing entropy encoding based on the initialized internal state information on a fourth row of blocks that belong to the same thread as the first row of blocks and are processed subsequent to the first row of blocks, wherein in order to initialize the internal state information, in the picture including the image, it is impossible to select whether the internal state information of the entropy encoded bit string is initialized after entropy encoding performed on a last block for every row of blocks.

The image may be one of slice segments generated by splitting a picture in a horizontal direction or one of tiles generated by splitting the picture in horizontal and vertical directions, and blocks of the image may be largest coding units (LCUs) each including coding units of a tree structure, and each of the first row of blocks and the second row of blocks may be a group of LCUs that are serially arranged in the horizontal direction.

According to another aspect of the present invention, there is provided an entropy decoding method for video decoding, the entropy decoding method including: from a received bitstream, extracting a first row of blocks and a second row of blocks which each include a bit string of blocks serially arranged in a horizontal direction from among blocks that each have a predetermined size and are obtained by splitting and encoding an image; sequentially restoring symbols of blocks of the first row of blocks by performing entropy decoding on the first row of blocks; determining initial entropy coding probability information of a foremost block of the second row of blocks as entropy coding probability information updated by a block of a fixed position of the first row of blocks, performing entropy decoding on the foremost block of the second row of blocks based on the determined initial entropy coding probability information, and sequentially restoring symbols of blocks of the second row of blocks; and after completing the entropy decoding performed to a last block of the first row of blocks, initializing internal state information of a bit string of the first row of blocks.

The sequentially restoring of the symbols of the blocks of the second row of blocks may include: in order to determine initial entropy coding probability information of the foremost block of the second row of blocks, referring to entropy coding probability information updated by a second block of the first row of blocks which is located at a right upper side of the foremost block of the second row of blocks, and in order to determine a block which is to be referred to in order to determine the initial entropy coding probability information of the foremost block of the second row of blocks, information about when context synchronization between the first row of blocks and the second row of blocks occurs in a picture including the image is not parsed from the bitstream.

The sequentially restoring of the symbols of the blocks of the second row of blocks may include, after obtaining entropy coding probability information updated based on symbols of the second block of the first row of blocks, starting to perform entropy decoding beginning from the foremost block of the second row of blocks, wherein the entropy decoding method further includes, after obtaining entropy coding probability information updated by a second block of the second row of blocks, starting to perform entropy decoding on a third row of blocks that are disposed under the second row of blocks to be adjacent to the second row of blocks beginning from a foremost block of the third row of blocks.

The initializing of the internal state information of the bit string of the first row of blocks may include: in a buffer in which the bit string of the first row of blocks is stored, initializing to a default value offset information indicating a position where a code of the last block contacting a boundary of the image is stored and range information indicating a range of code intervals; and performing entropy decoding based on the initialized internal state information on a next bit string that belongs to the same thread as the first row of blocks and is processed subsequent to the bit string of the first row of blocks and restoring blocks of a fourth row of blocks, wherein in order to initialize the internal state information, in a picture including the image, information about whether the internal state information is initialized is not parsed from the bitstream after entropy decoding performed on a last block for every row of blocks.

The image may be one of slice segments generated by splitting a picture in a horizontal direction or one of tiles generated by splitting the picture in horizontal and vertical directions, and blocks of the image may be LCUs each including coding units of a tree structure, and each of the first row of blocks and the second row of blocks may be a group of LCUs that are serially arranged in the horizontal direction.

When the entropy decoding method is performed by using two or more processing cores, the sequentially restoring of the symbols of the blocks of the first row of blocks may include, by using a first processing core, performing entropy decoding beginning from a second block of the first row of blocks by using entropy coding probability information updated based on symbols of a foremost block of the first row of blocks, the sequentially restoring of the symbols of the blocks of the second row of blocks includes, by using a second processing core, right after obtaining entropy coding probability information updated based on symbols of the second block of the first row of blocks, starting to perform entropy decoding on the second row of blocks beginning from the foremost block of the second row of blocks by using the obtained entropy coding probability information, and an entropy decoding operation of the second processing core performed on the second row of blocks is delayed by as much as a time taken to obtain the entropy coding probability information updated based on the symbols of the second block of the first row of blocks from an entropy decoding operation of the first processing core performed on the first row of blocks.

When the entropy decoding method is performed by using one processing core, the entropy decoding method may include: by using a first processing core, restoring symbols of the first row of blocks by sequentially performing entropy decoding on blocks of the first row of blocks by using a first processing core; by using the first processing core, after the entropy decoding is completed to a last block of the first row of blocks, initializing internal state information of a bit string of the first row of blocks; by using the first processing core, determining initial entropy coding probability information of the foremost block of the second row of blocks as entropy coding probability information updated by symbols of a second block of the first row of block, and sequentially restoring symbols of blocks of the second row of blocks by performing entropy decoding on the foremost block of the second row of blocks based on the determined initial entropy coding probability information; by using the first processing core, after completing the entropy decoding to a last block of the second row of blocks, initializing internal state information of a bit string of the second row of blocks; and by using the first processing core, determining initial entropy coding probability information of a foremost block of a third row of blocks that are disposed under the second row of blocks to be adjacent to the second row of blocks as entropy coding probability information updated by symbols of a second block of the second row of blocks, performing entropy decoding on the foremost block of the third row of blocks by using the initialized internal state information of the bit string of the first row of blocks and the determined initial entropy coding probability information, and sequentially restoring symbols of blocks of the third row of blocks.

According to another aspect of the present invention, there is provided an entropy encoding apparatus for video encoding, the entropy encoding apparatus including: a first entropy encoder that sequentially performs entropy encoding on blocks of a first row of blocks which are serially arranged in a horizontal direction from among blocks that each have a predetermined size and are obtained by splitting and encoding an image; and a second entropy encoder that determines initial entropy coding probability information of a foremost block of a second row of blocks which are disposed under the first row of blocks to be adjacent to the first row of blocks as entropy coding probability information updated by a block of a fixed position of the first row of blocks, performs entropy encoding on the foremost block of the second row of blocks based on the determined initial entropy coding probability information, and sequentially performs entropy encoding on blocks of the second row of blocks which are serially arranged, wherein after the entropy encoding is completed to a last block of the first row of blocks, the first entropy encoder initializes internal state information of an entropy encoded bit string of the first row of blocks.

According to another aspect of the present invention, there is provided an entropy decoding apparatus for video decoding, the entropy decoding apparatus including: a receiver that extracts, from a received bitstream, a first row of blocks and a second row of blocks each including a bit string of blocks serially arranged in a horizontal direction from among blocks that each have a predetermined size and are obtained by splitting and encoding an image; a first entropy decoder that performs entropy decoding on the first row of blocks and sequentially restores symbols of blocks of the first row of blocks; and a second entropy decoder that determines initial entropy coding probability information of a foremost block of the second row of blocks as entropy coding probability information updated by a block of a fixed position of the first row of blocks, performs entropy decoding on the foremost block of the second row of blocks based on the determined initial entropy coding probability information, and sequentially restores symbols of blocks of the second row of blocks, wherein after the entropy decoding is completed to a last block of the first row of blocks, the first entropy decoder initializes internal state information of a bit string of the first row of blocks.

According to another aspect of the present invention, there is provided a non-transitory computer-readable recording medium for executing the method.

### MODE FOR THE INVENTION

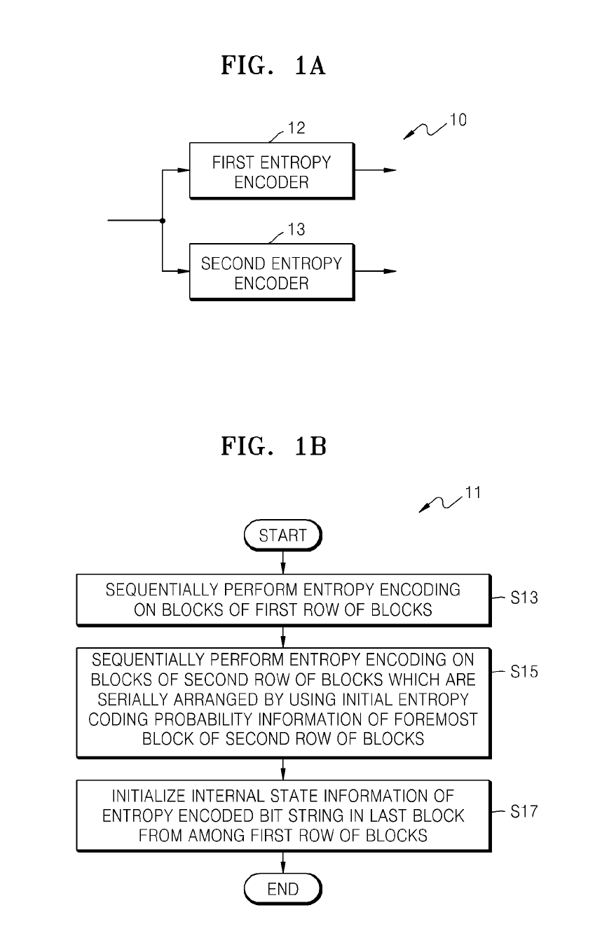

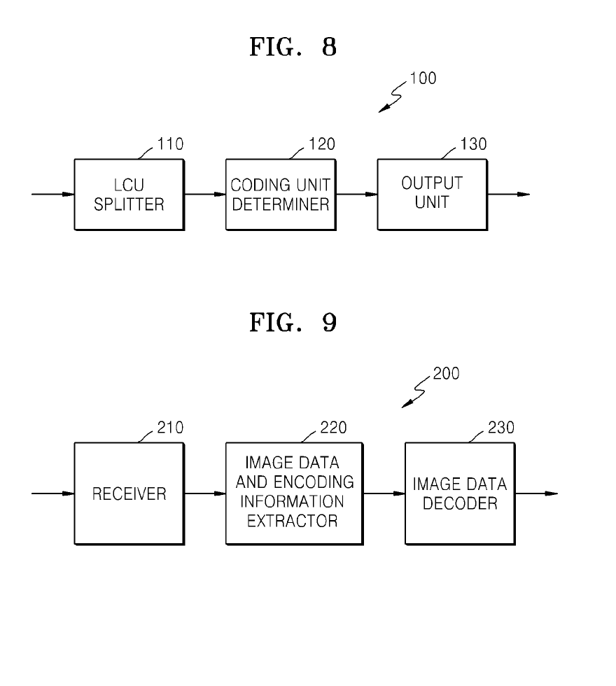

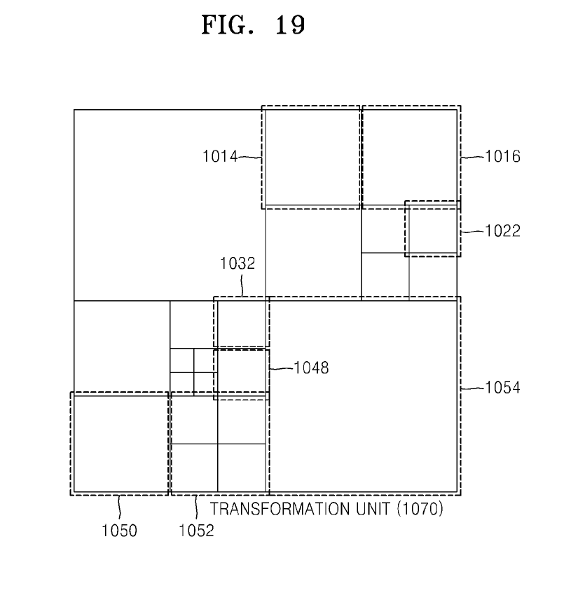

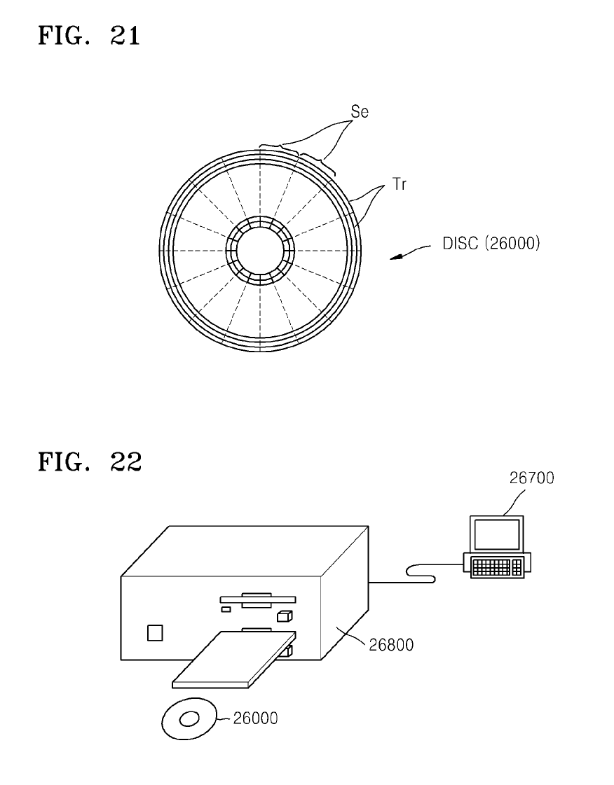

An entropy encoding apparatus for video encoding and an entropy decoding apparatus for video decoding and an entropy encoding method and an entropy decoding method thereof according to an embodiment of the present invention will be explained with reference to FIGS. 1A through 7. Also, a video encoding apparatus using an entropy encoding method and a video decoding apparatus using an entropy decoding method based on coding units of a tree structure, and a video encoding method and a video decoding method thereof according to an embodiment of the present invention will be explained with reference to FIGS. 8 through 20. Various embodiments to which a video encoding method and a video decoding method may be applied will be explained with reference to FIGS. 21 through 27. Hereinafter, the term ‘image’ may refer to a still image, a moving image, or a video itself.

An entropy encoding apparatus and an entropy encoding method, and an entropy decoding apparatus and an entropy decoding method according to an embodiment of the present invention will be explained with reference to FIGS. 1A through 7.

FIG. 1A is a block diagram illustrating an entropy encoding apparatus 10 according to an embodiment of the present invention.

The entropy encoding apparatus 10 includes a first entropy encoder 12 and a second entropy encoder 14.

The entropy encoding apparatus 10 receives symbols that are generated by encoding each of images constituting a video in units of blocks. The symbols may be generated by performing intra prediction/inter prediction, transformation, and quantization in units of blocks on video data of a spatial domain.

For convenience of explanation, a video encoding technique or an entropy encoding technique for a ‘block’ which is a data unit will be explained in detail. However, a video encoding technique according to various embodiments of the present invention is not limited to a video encoding technique for a ‘block’, and may be applied to various data units.

In order to efficiently encode an image, the image is encoded after being split into blocks each having a predetermined size. Each of the blocks may have a square shape, a rectangular shape, or an arbitrary geometrical shape, and is not limited to a data unit having a predetermined size. The block according to an embodiment may be a largest coding unit (LCU), a coding unit, a prediction unit, or a transformation unit, from among coding units according to a tree structure. A video encoding/decoding method based on coding units according to a tree structure will be explained with reference to FIGS. 8 through 20.

Also, the term ‘image’ may refer to a picture, one of slice segments generated by splitting a picture in a horizontal direction, or one of tiles generated by splitting a picture in horizontal and vertical directions.

The first entropy encoder 12 sequentially performs entropy encoding on blocks of a first row of blocks which are serially arranged in a horizontal direction, from among blocks of an image. The second entropy encoder 14 sequentially performs entropy encoding on blocks of a second row of blocks which are disposed under the first row of blocks to be adjacent to the first row of blocks.

When each of the blocks is an LCU from among coding units according to a tree structure, each of the first row of blocks and the second row of blocks may be a group of LCUs that are serially arranged in the horizontal direction.

Entropy encoding according to an embodiment of the present invention may include a digitization process that converts a symbol into a bit string, and an arithmetic coding process that performs context-based arithmetic coding on the bit string. A context adaptive binary arithmetic coding (CABAC) is widely used as an arithmetic coding method that performs context-based arithmetic coding. According to context-based arithmetic encoding/decoding, each bit of a symbol bit string may be each bin of a context, and a position of each bit may be mapped to a bin index. A length of a bit string, that is, a length of bins may vary according to a size of a symbol value. In order to perform context-based arithmetic encoding/decoding, context modeling for determining a context of a symbol is necessary.

In order to perform context modeling, a context needs to be updated for every position of a bit of a symbol bit string, that is, for every bin index. Here, the term ‘context modeling’ refers to a process of analyzing a probability that each bit has 0 or 1. A process of updating a context by reflecting a result obtained by analyzing a probability of each bit of symbols of a new block on contexts so far may be repeatedly performed for every block. A probability table showing a probability of each bin may be provided as information about a result of the context modeling. Entropy coding probability information according to an embodiment may be information about a result of context modeling.

Accordingly, once context modeling information, that is, entropy coding probability information, is obtained, entropy encoding may be performed by allocating a code to each bit of a bit string that is binarized from block symbols based on a context of the entropy coding probability information.

Accordingly, a method performed by the first entropy encoder 12 and the second entropy encoder to obtain entropy coding probability information in order to perform entropy encoding in units of blocks will be explained in detail with reference to FIG. 1B.

FIG. 1B is a flowchart illustrating an entropy encoding method 11 performed by the entropy encoding apparatus 10 of FIG. 1A.

In operation S13, the first entropy encoder 12 sequentially performs entropy encoding on blocks of a first row of blocks which are serially arranged in a horizontal direction. Initial entropy coding probability information for a block that is to be first processed from among blocks of the first row of blocks may be determined as default probability information. The first entropy encoder 12 may perform entropy encoding on a second block of the first row of blocks by using entropy coding probability information updated based on symbols of the foremost block of the first row of blocks.

In operation S15, the second entropy encoder 14 may determine initial entropy coding probability information of a foremost block of a second row of blocks as entropy coding probability information updated by a block of a fixed position of the first row of blocks. The second entropy encoder 14 may perform entropy encoding on the foremost block of the second row of blocks based on the initial entropy coding probability information. Beginning from the foremost block, the second entropy encoder 14 may sequentially perform entropy encoding on blocks of the second row of blocks which are serially arranged.

The block of the fixed position which is referred to in order to obtain the initial entropy coding probability information of the foremost block of the second row of blocks may be a block that is located at a right upper side of the foremost block of the second row of blocks. Accordingly, in order to determine the initial entropy coding probability information of the foremost block of the second row of blocks, the second entropy encoder 14 may refer to entropy coding probability information updated by the second block of the first row of blocks which is located at the right upper side of the foremost block of the second row of blocks.

In order to determine a block that is to be referred to in order to determine the initial entropy coding probability information of the foremost block of the second row of blocks, the second entropy encoder 14 may skip analyzing when context synchronization between the first row of blocks and the second row of blocks occurs. A process of determining when context synchronization between the first row of blocks and the second row of blocks occurs may not be performed on all rows of blocks of a picture.

Also, since the second entropy encoder 14 may determine the block that is referred to in order to obtain the initial entropy coding probability information of the foremost block of the second row of blocks at a fixed position, instead of a variable position, a process of selecting a reference block from among various blocks is not required.

After obtaining the entropy coding probability information updated based on symbols of the second block of the first row of blocks, the second entropy encoder 14 may start to perform entropy encoding beginning from the foremost block of the second row of blocks.

Likewise, in order to perform entropy encoding on a third row of blocks which are disposed under the second row of blocks to be adjacent to the second row of blocks, the entropy encoding apparatus 10 may start to perform entropy encoding on blocks of the third row of blocks beginning from a foremost block of a third row of blocks after obtaining entropy coding probability information updated by the second block of the second row of blocks.

Accordingly, an entropy encoding operation for the second row of blocks may be delayed by as much as a time taken to obtain the entropy coding probability information updated based on the symbols of the second block of the first row of blocks from an entropy encoding operation for the first row of blocks.

In operation S17, after completing the entropy encoding on the blocks of the first row of blocks to a last block of the first row of blocks, the first entropy encoder 12 initializes internal state information of an entropy encoded bit string of the first row of blocks. Also, after completing the entropy encoding on the blocks of the second row of blocks to a last block of the second row of blocks, the second entropy encoder 14 may initialize internal state information of an entropy encoded bit string of the second row of blocks.

When a bit string is generated by performing entropy encoding on the first row of blocks, the first entropy encoder 12 stores the bit string in a buffer. Internal state information of an entropy encoded bit string according to an embodiment may include offset information indicating a position where a code of a last block adjacent to a boundary of an image is stored and range information indicating a range of code intervals. The first entropy encoder 12 may initialize offset information and range information of the bit string of the first row of blocks as a default value.

A data unit which a processing core processes at one time may be referred to as a thread. In a wavefront parallel processing method according to an embodiment, each row of blocks may be processed as one thread. For example, when entropy encoding on a first row of blocks, a second row of blocks, and a third row of blocks is performed in a parallel manner, the first row of blocks may correspond to a first thread, the second row of blocks may correspond to a second thread, and the third row of blocks may correspond to a third thread. When a multi-thread processing method is limited to 3 threads, a fourth row of blocks, a fifth row of blocks, and a sixth row of blocks which are sequentially adjacent to one another under the third row of blocks may respectively correspond to the first thread, the second thread, and the third thread.

The fourth row of blocks corresponding to the first thread may be entropy encoded subsequent to the first row of blocks, the fifth row of blocks may be entropy encoded subsequent to the second row of blocks, and the sixth row of blocks may be entropy encoded subsequent to the third row of blocks.

Accordingly, in order to perform entropy encoding on the fourth row of blocks subsequent to the first row of blocks according to the first thread, the first entropy encoder 12 may perform entropy encoding on a foremost block of the fourth row of blocks based on internal state information initialized after encoding of a last block of the first row of blocks.

In particular, in order to initialize internal state information, the first entropy encoder 12 according to an embodiment does not determine whether internal state information of a bit string entropy encoded after entropy encoding of a last block for every row of blocks of a picture including an image.

Also, in order to perform entropy encoding on the fifth row of blocks subsequent to the second row of blocks according to the second thread, the second entropy encoder 14 may perform entropy encoding on a foremost block of the fifth row of blocks based on internal state information initialized after encoding of a last block of the second row of blocks.

Likewise, since internal state information of a bit string buffer is initialized after a last block for each row of blocks is entropy encoded, there is no need to determine a possibility of initialization.

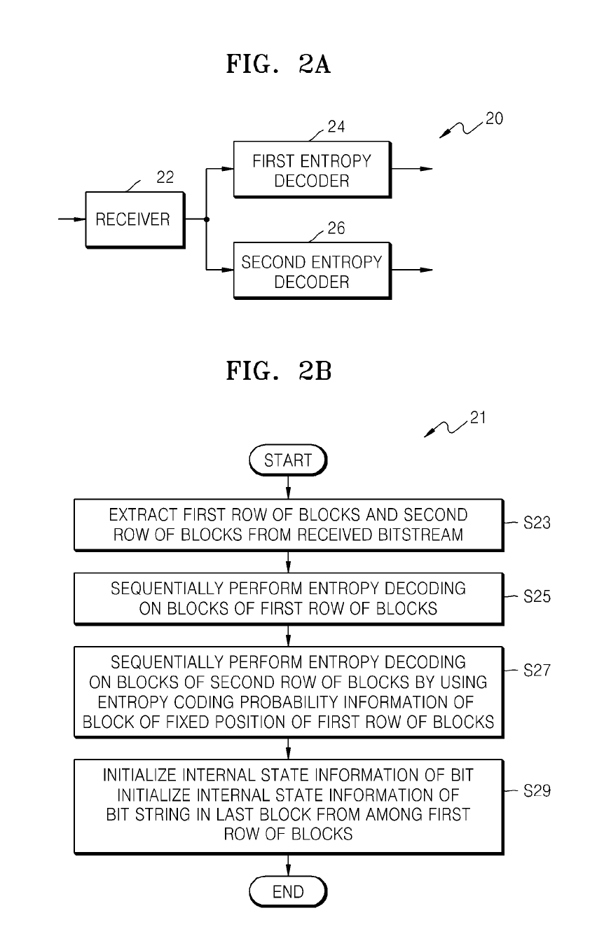

A method of restoring block symbols from a bit string entropy encoded to process rows of blocks in a parallel manner as described with reference to FIGS. 1A and 1B will be explained in detail with reference to FIGS. 2A and 2B.

FIG. 2A is a block diagram illustrating an entropy decoding apparatus 2 according to an embodiment of the present invention.

The entropy decoding apparatus 20 includes a receiver 22, a first entropy decoder 24, and a second entropy decoder 26.

The receiver 22 receives a bitstream including coding data of a video. The bitstream may include bit strings generated by entropy encoding on block symbols of each of images constituting the video.

A video decoding technique or an entropy decoding technique for a ‘block’ that is a data unit will be explained in detail. As described with reference to FIG. 1A, the ‘block’ may be applied to various data units based on coding units of a tree structure. The ‘image’ may be one of a picture, a slice segment, and a tile.

The receiver 22 may extract from the received bitstream a first row of blocks and a second row of blocks including an encoded bit string of image blocks, and may respectively output the first row of blocks and the second row of blocks to the first entropy decoder 24 and the second entropy decoder 26.

The first entropy decoder 24 may sequentially restore symbols of blocks of the first row of blocks by performing entropy decoding on the first row of blocks.

The second entropy decoder 26 may sequentially restore symbols of blocks of the second row of blocks by performing entropy decoding on the second row of blocks.

The blocks restored by the first entropy decoder 24 and the second entropy decoder 24 may be groups of LCUs of the first row of blocks and the second row of blocks which are serially arranged in a horizontal direction.

Video data of a spatial domain may be restored for each block by performing inverse quantization, inverse transformation, and intra prediction/motion compensation in units of blocks on the block symbols restored by the entropy decoding apparatus 20.

A method performed by the first entropy decoder 24 and the second entropy decoder 26 to obtain entropy coding probability information in order to perform entropy decoding in units of blocks will be explained in detail with reference to FIG. 2B.

FIG. 2B is a flowchart illustrating an entropy decoding method 21 performed by the entropy decoding apparatus 20 of FIG. 2A.

In operation S23, the receiver 22 extracts a first row of blocks and a second row of blocks from a bitstream. In operation S25, the first entropy decoder 24 may sequentially restore symbols of blocks of the first row of blocks by performing entropy decoding on the first row of blocks.

In operation S27, the second entropy decoder 26 may determine initial entropy coding probability information of a foremost block of the second row of blocks as entropy coding probability information updated by a block of a fixed position of the first row of blocks.

In order to determine the initial entropy coding probability information of the foremost block of the second row of blocks, the second entropy decoder 26 may refer to entropy coding probability information updated by a second block of the first row of blocks which is located at a right upper side of the foremost block of the second row of blocks.

In order to determine a block that is to be referred to in order to determine the initial entropy coding probability information of the foremost block of the second row of blocks, the second entropy decoder 26 may skip parsing information about how long entropy encoding on the second row of blocks is delayed from entropy encoding on the first row of blocks. The second entropy decoder 26 does not determine when context synchronization between the first row of blocks and the second row of blocks occurs.

Also, since the second entropy decoder 26 may determine the block that is referred to in order to obtain the initial entropy coding probability information of the foremost block of the second row of blocks at a fixed position instead of a variable position, an operation of selecting a reference block from among various blocks is not required.

The second entropy decoder 26 may perform entropy decoding on the foremost block of the second row of blocks based on the determined initial entropy coding probability information. The second entropy decoder 26 may perform entropy decoding on a second block based on a result obtained by parsing the foremost block of the second row of blocks. In this manner, block symbols of the second row of blocks may be sequentially restored.

Also, since after obtaining the entropy coding probability information updated based on symbols of the second block of the first row of blocks, the second entropy decoder 26 starts to perform entropy decoding on the blocks of the second row of blocks beginning from the foremost block of the second row of blocks, an entropy decoding operation of the second row of blocks may be delayed until the entropy coding probability information updated by the second block of the first row of blocks is obtained.

Likewise, after obtaining entropy coding probability information updated by the second block of the second row of blocks, the entropy decoding apparatus 20 may start to perform entropy decoding on a third row of blocks which are disposed under the second row of blocks to be adjacent to the second row of blocks.

In operation S27, after completing the entropy decoding on the blocks of the first row of blocks to a last block of the first row of blocks, the first entropy decoder 24 may initialize internal state information of a bit string of the first row of blocks.

After the entropy decoding is completed to the last block of the first row of blocks, offset information and range information of a buffer in which a code of the last block of the first row of blocks is stored which are the internal state information of the bit string of the first row of blocks may be initialized as a default value.

The first entropy decoder 24 may restore blocks of a fourth row of blocks by performing entropy decoding based on the initialized internal state information on a next bit string which belongs to the first thread and is subsequent to the first row of blocks.

In this case, in a picture including an image, information about whether internal state information of a bit string is initialized after a last block of each row of blocks is entropy decoded is not parsed from the bitstream. Accordingly, the first entropy decoder 24 does not need to determine whether internal state information is initialized in the last block of the first row of blocks.

Since the bitstream contains a bit string entropy encoded to be processed in a parallel manner, entropy decoding may be performed on the bitstream by using two or more processes.

When the entropy decoding apparatus 20 includes two processing cores, the first entropy decoder 24 that performs entropy decoding on the first row of blocks and the second entropy decoder 26 that performs entropy decoding on the second row of blocks may operate by using different processing cores.

For example, under the control of a first processing core, after parsing symbols of a foremost block of the first row of blocks, the first entropy decoder 24 may update entropy coding probability information based on the symbols of the foremost block of the first row of blocks, and may perform entropy decoding beginning from a second block of the first row of blocks by using the updated entropy coding probability information. The first entropy decoder 24 may restore symbols of the second block of the first row of blocks and then may update again the entropy coding probability information based on the restored symbols.

At the same time, under the control of a second processing core, right after receiving the entropy coding probability information updated based on the symbols of the second block of the first row of blocks, the second entropy decoder 26 may perform entropy decoding on a foremost block of the second row of blocks by using the obtained entropy coding probability information.

Since the first processing core and the second processing core may simultaneously individually operate, entropy decoding on the first row of blocks and entropy decoding on the second row of blocks may be performed in a parallel manner. However, an entropy decoding operation of the second processing core on the second row of blocks is delayed by as much as a time taken to obtain the entropy coding probability information updated based on the symbols of the second block of the first row of blocks from an entropy decoding operation of the first processing core on the first row of blocks as described above.

Also, when the entropy decoding apparatus 20 includes only one processing core, the one processing core may perform operations of both the first entropy decoder 24 and the second entropy decoder 26. In this case, since the first entropy decoder 24 and the second entropy decoder 26 may not simultaneously operate, under the control of the one processing core, the first entropy decoder 24 may sequentially perform entropy decoding on blocks of the first row of blocks, and after the entropy decoding is completed to a last block of the first row of blocks, the first entropy decoder 24 may initialize internal state information of the first row of blocks.

Next, under the control of the one processing core, the second entropy decoder 26 may perform entropy decoding on a foremost block of the second row of blocks by determining initial entropy coding probability information of the foremost block of the second row of block as entropy coding probability information updated by symbols of a second block of the first row of blocks, and sequentially restore symbols of blocks of the second row of blocks. After the entropy decoding is completed to a last block of the second row of blocks under the control of the one processing core, internal state information of a bit string of the second row of blocks may be initialized.

Next, under the control of the one processing core, the first entropy decoder 24 may determine initial entropy coding probability information of a foremost block of a third row of blocks which are disposed under the second row of blocks to be adjacent to the second row of blocks as entropy coding probability information updated by symbols of a second block of the second row of blocks, and perform entropy decoding on the foremost block of the third row of blocks by using the initialized internal state information of the bit string of the second row of blocks and the determined entropy coding probability information. Accordingly, under the control of the one processing core, symbols of blocks of the third row of blocks may also be sequentially restored.

Accordingly, even when one processing core is used, the entropy decoding apparatus 20 may restore block symbols by sequentially performing entropy decoding on all rows of blocks which are encoded to be processed in a parallel manner.

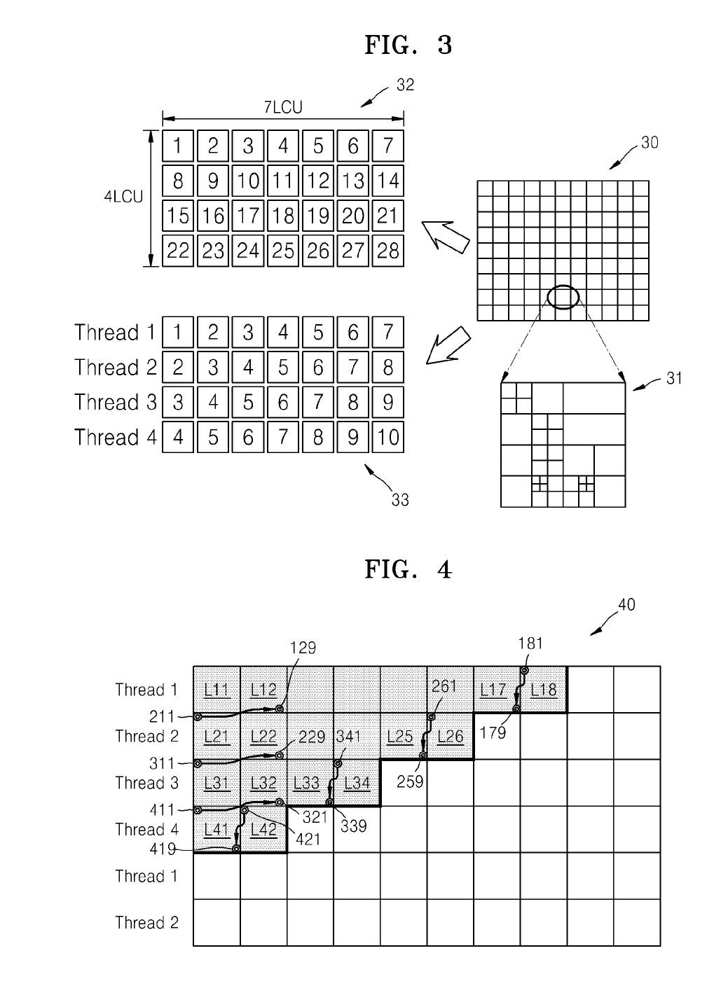

A parallel processing structure for entropy encoding and entropy decoding according to an embodiment of the present invention will be explained in detail with reference to FIGS. 3 through 7.

FIG. 3 is a diagram for explaining a regular coding order and a wavefront coding order of blocks.

An image 30 is split into a plurality of blocks each having a predetermined size. Each of the blocks is an LCU, and the LCU includes coding units 31 according to a tree structure. A video encoding apparatus and a video decoding apparatus according to an embodiment may independently perform intra estimation (intra prediction)/motion estimation (motion compensation), transformation (inverse transformation), quantization (inverse quantization), in-loop filtering, sample adaptive offset (SAO) compensation for every LCU.

In the video encoding apparatus, the coding units 31 of the tree structure constituting each LCU may split an LCU according to steps into sub-blocks, perform intra estimation (intra prediction)/motion estimation (motion compensation), transformation (inverse transformation), or quantization (inverse quantization) on each of the sub-blocks, and determine sub-blocks with highest coding efficiency. A size of a sub-block may vary according to how many number of times the LCU is split to obtain the sub-block. Even in one LCU, since characteristics of regions in the one LCU vary according to spatial location, a size of a sub-block with highest coding efficiency in a region may be individually determined to be different from those of other regions.

A finally determined sub-block may be referred to as a coding unit. Accordingly, since one LCU includes coding units that have various sizes and are obtained by splitting the LCU different number of times, the LCU may be referred to as the coding units 31 according to a tree structure.

Also, since each LCU is individually encoded, a tree structure of the coding units 31 constituting each LCU may be individually determined to be different from those of other LCUs.

A process performed by the video encoding apparatus to encode an LCU into sub-domains according to steps and finally determining the coding units 31 according to a tree structure, and a process performed by the video decoding apparatus to read the coding units 31 according to the tree structure of the LCU, performing decoding for every coding unit, and restoring image data of the LCU will be explained with reference to FIGS. 8 through 20.

A regular coding order 32 and a wavefront coding order 33 refer to orders in which LCUs are encoded/decoded. Entropy encoding may be performed for every LCU in the regular coding order 32 or the wavefront coding order 33.

Entropy decoding may be performed on LCUs in the same order as a coding order in which entropy encoding is performed on the LCUs. That is, when a bitstream is output by performing entropy encoding on LCUs in the regular coding order 32, the LCUs may be sequentially parsed in the regular coding order 32 from the bitstream in order to perform entropy decoding. The same applies to the wavefront coding order 33.

Each of the regular coding order 32 and the wavefront coding order 33 is an order in which entropy encoding is performed on an image composed of 28 LCUs including 7 LCUs that are serially arranged in a horizontal direction and 4 LCUs that are serially arranged in a vertical direction. A number written in each LCU denotes a coding order, and the smaller the number is, the earlier the coding order is, and the largest the number is, the later the coding order is.

In the regular coding order 32, encoding is sequentially performed, beginning from a leftmost LCU of a first row of LCUs that are an uppermost row of LCUs, on LCUs of the first row of LCUs in the horizontal direction. After the encoding is performed to a rightmost LCU of the first row of LCUs, encoding is sequentially performed, beginning from a leftmost LCU of a second row of LCUs which are disposed under the first row of LCUs to be adjacent to the first row of LCUs, on LCUs of the second row of LCUs. In this manner, encoding may be performed to a rightmost LCU of a fourth row of LCUs that are a lowermost row of LCUs. Also, since encoding is sequentially performed on the 28 LCUs one by one, entropy encoding may be completed after a total of 28 encoding operations are sequentially performed.

In the wavefront coding order 33, the fact that encoding is sequentially performed on LCUs that are arranged in the horizontal direction from a leftmost LCU to a rightmost LCU for each row of LCUs is the same as that in the regular coding order 32. However, in the wavefront coding order 33, parallel entropy encoding may be performed on a plurality of rows of LCUs. That is, entropy encoding on a first row of LCUs is performed by using a first thread, entropy encoding on a second row of LCUs is performed by using a second thread, entropy encoding on a third row of LCUs is performed by using a third thread, and entropy encoding on a fourth row of LCUs is performed by using a fourth thread.

However, a general parallel processing order and the wavefront coding order 33 are different from each other in that there is a time interval between threads. That is, (i) entropy encoding is first performed beginning from a foremost LCU of a first row of LCUs by using the first thread. (ii) When entropy encoding is performed on a second LCU of the first row of LCUs by using the first thread, entropy encoding may start to be performed beginning from a foremost LCU of a second row of LCUs by using the second thread. (iii) When entropy encoding is performed on a third LCU of the first row of LCUs by using the first thread, entropy encoding may be performed on a second LCU of the second row of LCUs by using the second thread, and entropy encoding may start to be performed beginning from a foremost LCU of the third row of LCUs by using the third thread. (iv) When entropy encoding is performed on a fourth LCU of the first row of LCUs by using the first thread, entropy encoding may be performed on a third LCU of the second row of LCUs by using the second thread, entropy encoding may be performed on a second LCU of the third row of LCUs by using the third thread, and entropy encoding may start to be performed beginning from a foremost LCU of a fourth row of LCUs by using the fourth thread.

Since entropy encoding starts with a time interval between threads, there may be a time difference between threads in terms of a time when entropy encoding ends at a last LCU of each row of LCUs. As a result, since entropy encoding has to be performed on 7 LCUs for each thread and entropy encoding starts and ends with a time interval of one LCU between threads, entropy encoding may be completed after a total of 10 encoding operations are performed on the 28 LCUs including 4 rows of LCUs.

Each of the entropy encoding apparatus 10 and the entropy decoding apparatus 20 may perform entropy encoding and entropy decoding in the wavefront coding order 33. An entropy encoding method and an entropy decoding method in a wavefront coding order will be explained in detail with reference to FIG. 4.

FIG. 4 is a diagram for explaining a wavefront coding order and a method of determining entropy coding probability information, according to an embodiment of the present invention.

The entropy encoding apparatus 10 may obtain a bitstream by performing parallel entropy encoding on rows of LCUs in a wavefront coding order. Also, the entropy decoding apparatus 20 may perform parallel entropy decoding on rows of LCUs by sequentially parsing LCUs that are arranged in a wavefront coding order from a bitstream.

In particular, when a processing core of the entropy encoding apparatus 10 is a multi-core processor, since processing cores may perform entropy encoding by using different threads, entropy encoding may be simultaneously performed on a plurality of rows of LCUs. Also, in a wavefront coding order, the processing cores of the entropy encoding apparatus 10 may simultaneously perform entropy encoding on different rows of LCUs at time intervals.

Also, when the entropy decoding apparatus 20 includes a multi-core processor, since rows of LCUs parsed from a bitstream may be divided according to threads and processing cores use threads at time intervals, entropy decoding may be performed on different rows of LCUs at time intervals.

A neighboring LCU adjacent to a current LCU may become a reference LCU in various operations performed during a process of encoding the current LCU. For example, a reference block for intra prediction, a reference block for motion vector prediction, a reference block for merging LCUs, and a reference block for symbol prediction such as SAO parameter prediction may be selected from among neighboring blocks adjacent to a current block.

A wavefront coding order has an advantage in that even when a neighboring LCU located at an upper side of a current LCU and a neighboring LCU located a right upper side of the current LCU which become reference blocks needed during a process of encoding the current LCU are processed by using other threads, the neighboring LCUs may be encoded earlier than the current LCU. Referring to FIG. 4, since encoding using a first thread is performed earlier by 2LCUs than encoding using a second thread, when encoding is performed on an LCU L21 of the second thread, encoding on LCUs L11 and L12 of the first thread has already been completed. Accordingly, symbols of the LCUs L11 and L12 may be referred to in order to encode the LCU L21.

Accordingly, although the entropy encoding apparatus 10 and the entropy decoding apparatus 20 process LCUs in a wavefront coding order by using independent threads, since the entropy encoding apparatus 10 and the entropy decoding apparatus 20 may obtain information of a reference block of a neighboring row of blocks needed during encoding/decoding, the entropy encoding apparatus 10 and the entropy decoding apparatus 20 may effectively perform parallel encoding/decoding.

Since the entropy encoding apparatus 10 and the entropy decoding apparatus 20 perform arithmetic encoding/decoding on symbols for every LCU, symbol code probability information is necessary. Also, since the entropy encoding apparatus 10 and the entropy decoding apparatus 20 perform arithmetic encoding/decoding based on a context, symbol code probability information may be updated for every LCU.

The entropy encoding apparatus 10 and the entropy decoding apparatus 20 may obtain initial code probability information for every LCU, and may update the initial code probability information according to a probability of symbols of a current LCU.

For example, initial code probability information of a current LCU may be obtained from final code probability information updated by an LCU that has been encoded right before. In detail, initial code probability information 181 of an LCU L18 may be determined as final code probability information 179 of a left LCU L17. Likewise, initial code probability information 261 of an LCU L26 may be determined as final code probability information 259 of a left LCU L25, initial code probability information 341 of an LCU L34 may be determined as final code probability information 339 of a left LCU L33, and initial code probability information 421 of an LCU L42 may be determined as final code probability information 419 of a left LCU L41.

Also, the entropy encoding apparatus 10 and the entropy decoding apparatus 20 may determine initial code probability information of a foremost LCU L11 of a first row as default code probability information. Initial code probability information of foremost LCUs of other rows beginning from a second row may be determined as code probability information of an LCU with a largest amount of context information from among neighboring LCUs.

Accordingly, the entropy encoding apparatus 10 and the entropy decoding apparatus 20 may determine initial code probability information of a foremost LCU of a current row as final code probability information of an LCU that is located a right upper side of the foremost LCU, that is, a second LCU at an upper row.

In detail, initial code probability information 211 of a foremost LCU L21 of a second row may be determined as final code probability information 129 of an LCU L12 that is located at a right upper side of the foremost LCU L21. Likewise, initial code probability information 311 of a foremost LCU L31 of a third row may be determined as final code probability information 229 of an LCU L22 that is located at a right upper side of the foremost LCU L31, and initial code probability information 411 of a foremost LCU L41 of a fourth row may be determined as final code probability information 329 of an LCU L32 that is located at a right upper side of the foremost LCU L41.

Accordingly, in order to smoothly obtain initial code probability information of a foremost LCU for each row of LCUs, the entropy encoding apparatus 10 and the entropy decoding apparatus 20 may update code probability information according to symbols of a second LCU of each thread and store final code probability information in a buffer.

In order to obtain context-based code probability information for arithmetic encoding/decoding, the entropy encoding apparatus 10 and the entropy decoding apparatus 20 have to refer to code probability information of an LCU that is processed by an independent thread. Since the code probability information is already stored in a wavefront coding order, the entropy encoding apparatus 10 and the entropy decoding apparatus 20 may easily obtain the code probability information. Also, code probability information with a largest amount of context information may be obtained from among neighboring LCUs.

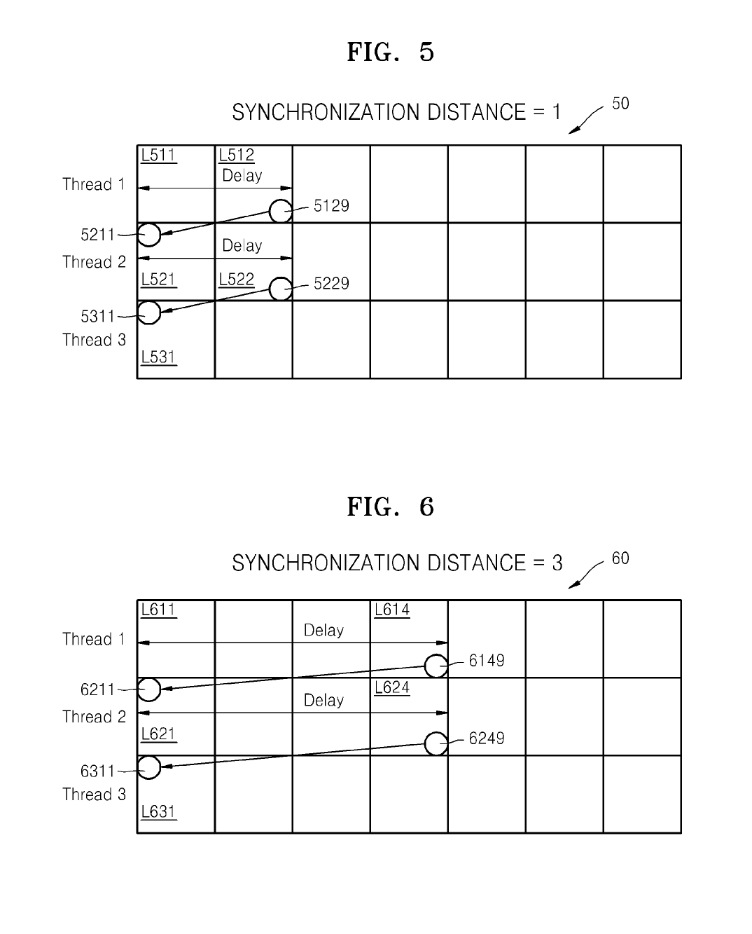

FIGS. 5 and 6 are diagrams illustrating a relationship between a synchronization distance and a delay time of a subordinated thread.

According to a related art, in order to perform parallel processing in a wavefront order, a delay time between neighboring LCUs may be adjusted. This relates to an issue of determining final code probability information of which LCU initial code is synchronized with probability information for performing entropy encoding/decoding on a current LCU or an issue of determining when context synchronization between a current row of LCUs and an upper row of LCUs occurs. This is because until final code probability information is determined in an LCU which is to be referred to, entropy encoding/decoding of a current LCU is delayed.

A horizontal distance between a current LCU and an LCU which is to be referred to is referred to as a ‘synchronization distance’.

FIG. 5 illustrates a case where a synchronization distance is 1. Initial code probability information of a foremost LCU of a current row may be determined as final code probability information of a second LCU that is located at a right upper side of the foremost LCU. Accordingly, while a foremost LCU L511 of a first thread is set as default code probability information, initial code probability information 5211 of a foremost LCU L521 of a second thread may be determined as final code probability information 5129 of a second LCU L512 of the first thread, and initial code probability information 5311 of a foremost LCU L531 of a third thread may be determined as final code probability information 5229 of a second LCU L522 of the second thread.

FIG. 6 is a diagram illustrating a case where a synchronization distance is 3. Initial code probability information of a foremost LCU of a current row may be determined as final code probability information of a fourth LCU of an upper row. Accordingly, while initial code probability information of a foremost LCU L611 of a first thread is set as default code probability information, initial code probability information 6211 of a foremost LCU L621 of a second thread may be determined as final code probability information 6149 of a fourth LCU L614 of the first thread, and initial code probability information 6311 of a foremost LCU L631 of a third thread may be determined as final code probability information 6249 of a fourth LCU L624 of the second thread.

Since the synchronization distance of FIG. 5 is short, code probability information with less updated contexts of LCUs is obtained. However, since a delay time of each row of LCUs is short, a time taken to perform entropy encoding or entropy decoding on an entire image 50 is also shortened.

Since the synchronization distance of FIG. 6 is long and thus entropy encoding or entropy decoding may be performed by using code probability information with more updated contexts of LCUs, entropy encoding and decoding performance may be excellent. However, since there is a great difference between times when processing performed on LCUs starts, a time taken to perform entropy encoding or entropy decoding on an entire image 60 become longer.

Also, according to the related art, there is a method of adjusting a synchronization distance by directly selecting an LCU that provides code probability information with highest entropy encoding performance. In this case, since an operation of determining whether a synchronization distance is variable and, when it is determined that the synchronization distance is variable, an operation of determining a reference block with highest performance by comparing entropy encoding performances by using code probability information of neighboring LCUs have to be additionally performed, the amount of calculation is greatly increased.

According to the related art, information about whether a synchronization distance is variable has to be transmitted after being added to image additional information such as sequence parameter set (SPS), picture parameter set (PPS), or slice segment header. A decoder may check a synchronization distance by parsing information about the synchronization distance from the image additional information such as SPS, PPS, APS, or slice segment header. After checking the synchronization distance, in order to obtain initial code probability information of a foremost LCU of a row of LCUs, final code probability information of an LCD that is spaced apart by the synchronization distance from the foremost LCU may be stored in a buffer for every current row of LCUs.

However, parallel entropy encoding or parallel entropy decoding is performed in order to reduce a processing time by simultaneously using threads for a plurality of rows of LCUs. Accordingly, it is not preferable that as a time difference between threads increases, an overall processing time increases.

Furthermore, even though entropy encoding performance or entropy decoding performance is improved due to code probability information with many updated contexts of LCUs, the improvement may be slight.

Accordingly, the entropy encoding apparatus 10 and the entropy decoding apparatus 20 may synchronize initial code probability information of a foremost LCU with final code probability information of an LCU that is located at an upper right side of the foremost LCU for each row of LCUs by fixing a synchronization distance to 1 as shown in FIG. 5. That is, since a block to be referred to for initial code probability information may be directly determined without considering whether to adjust a synchronization distance, a process needed to determine initial code probability information may be simplified and a processing time may be reduced.

Also, the entropy encoding apparatus 10 does not need to add information about a synchronization distance to SPS, PPS, APS, or slice segment header and transmit the information, and the entropy decoding apparatus 20 does not need to parse and read the information about the synchronization distance from the SPS, PPS, APS, or slice segment header.

Accordingly, since only a delay time as much as a time taken to process one LCU between threads occurs between adjacent rows of LCUs, a processing time which is expected to be reduced due to parallel entropy encoding or parallel entropy decoding may be further reduced.

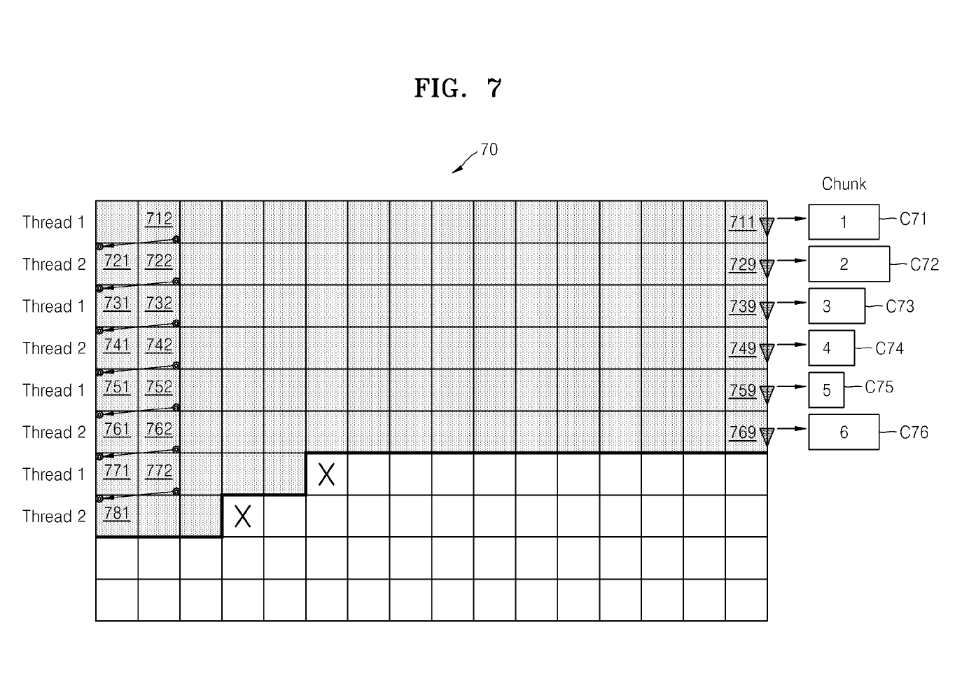

FIG. 7 is a diagram for explaining a process of performing simplified parallel entropy encoding/decoding, according to an embodiment of the present invention.

FIG. 7 illustrates a case where the entropy encoding apparatus 10 performs parallel entropy encoding by using two threads, that is, a first thread and a second thread. First, third, fifth, and seventh rows are encoded by using the first thread, and second, fourth, sixth, and eighth rows are encoded by using the second thread.

Since a synchronization distance for determining initial code probability information of a foremost LCU of each row of LCUs is fixed to 1, the entropy encoding apparatus 10 may determine the initial code probability information of the foremost LCU by referring to final code probability information of an LCU that is located at a right upper side of the foremost LCU for each row of LCUs.

That is, initial code probability information of a foremost LCU 721 of a second row may be determined as final code probability information of a second LCU 712 of a first row;

initial code probability information of a foremost LCU 731 of a third row may be determined as final code probability information of a second LCU 722 of the second row;

initial code probability information of a foremost LCU 741 of a fourth row may be determined as final code probability information of a second LCU 732 of the third row;

initial code probability information of a foremost LCU 751 of a fifth row may be determined as final code probability information of a second LCU 742 of the fourth row;

initial code probability information of a foremost LCU 761 of a sixth row may be determined as final code probability information of a second LCU 752 of the fifth row;

initial code probability information of a foremost LCU 771 of a seventh row may be determined as final code probability information of a second LCU 762 of the sixth row; and

initial code probability information of a foremost LCU 781 of an eighth row may be determined as final code probability information of a second LCU 772 of the seventh row.

Coding data generated through entropy encoding for each row of LCUs may be output in data units of chucks. Since image characteristics and symbols vary according to rows of LCUs, chucks C71, C72, C73, C74, C75, and C76 generated for respective rows of LCUs may be different from one another. Accordingly, in a buffer in which coding data generated for each row of LCUs is stored, positions and sizes of chucks may be different from one another.

When a first thread and a second thread are independently used by using a multi-core processor (or for other reasons), the chuck C73 may be generated from the third row after the chuck C71 is generated from the first row of the first thread. The chuck C74 may be generated from the fourth row after the chunk C72 is generated from the second row of the second thread. In this manner, when the first thread and the second thread are processed by using independent processing cores, the chucks C71, C73, C75, . . . generated by using the first thread may be serially stored in a first buffer, and the chunks C72, C74, C76, . . . generated by using the second thread may be stored in a second buffer.

However, when the first thread and the second thread are alternately used by using a single-core processor (or for other reasons), rows may be processed in an order of the first, second, third, fourth, fifth, sixth, and seventh rows. In this case, chunks may be stored in a buffer in an order of the chucks C71, C72, C73, C74, C75, and C76. Accordingly, when the first thread and the second thread are switched, after processing of a last LCU of each row of LCUs is completed, offset information indicating a position of data stored in each buffer and range information indicating a range in which the data is stored are necessary as information for determining a position of each chuck stored in each buffer. According to the related art, the offset information and the buffer information are stored as internal state information of the buffer.

However, even when the buffer offset information and the range information of the buffer are parsed as the internal state information of the buffer, it may be difficult to specify a boundary to actually separate generated data for each row of LCUs and thus data of rows of LCUs of different threads may overlap with each other.

According to the related art, there is a method of determining whether internal state information of a buffer is initialized in a last LCU of a row of LCUs for every sequence, picture, or slice segment. However, in this case, since ‘information about whether internal state information of a buffer is initialized in a last LCU of a row of LCUs’ has to be transmitted after being added to SPS, PPS, APS, or slice segment header, bits to be transmitted are increased. Also, additional processes such as an operation of parsing the ‘information about whether internal state information of a buffer in a last LCU of a row of LCUs is initialized’ from the SPS, PPS, APS, or slice segment header for the purpose of entropy decoding and an operation of determining whether the internal state information of the buffer is initialized according to a result of the parsing may be increased.

Accordingly, the entropy encoding apparatus 10 may generate an independent chunk based on independent internal state information for each row of LCUs in order to remove dependency on internal state information of a buffer. To this end, assuming that entropy encoding is performed on rows of LCUs by using a first thread and a second through, after last LCUs 719, 729, 739, 749, 759, and 769 of the respective rows of LCUs are processed, current buffer internal state information may be initialized. Accordingly, entropy encoding may be performed based on internal state information of a default value again in foremost LCUs of all of the rows of LCUs.

Likewise, assuming that the entropy decoding apparatus 20 restores the rows of LCUs by performing entropy decoding by using the first thread and the second thread, after the last LCUs 719, 729, 739, 749, 759, and 769 of the rows of LCUs are processed, current buffer internal state information may be initialized as a default value.

Also, the entropy encoding apparatus 10 does not need to add ‘information about whether internal state information of a buffer is initialized in a last LCU of a row of LCUs’ to SPS, PPS, APS, or slice segment header and transmit the information about whether internal state information of a buffer is initialized in a last LCU of a row of LCUs, and the entropy decoding apparatus 20 does not need to parse and read the ‘information about whether internal state information of a buffer is initialized in a last LCU of a row of the LCUs’ from the SPS, PPS, APS, or slice segment header.

Accordingly, the entropy encoding apparatus 10 and the entropy decoding apparatus 20 may simplify parallel entropy encoding and parallel entropy decoding while minimizing entropy encoding/decoding performance degradation by (i) determining an LCU that is to be referred to in order to determine initial code probability information of a foremost LCU for every row of LCUs at a closest fixed position and (ii) initializing internal state information of a buffer in a last LCU of the row of LCUs.

In the entropy encoding apparatus 10 and the entropy decoding apparatus 20, blocks in which video data is split are LCUs and each of the LCUs is split into coding units of a tree structure as described above. A video encoding method and apparatus, and a video decoding method and apparatus based on an LCU and coding units of a tree structure, according to an embodiment will be explained with reference to FIGS. 8 through 20.

FIG. 8 is a block diagram of a video encoding apparatus 100 based on coding units according to a tree structure, according to an embodiment of the present invention.

The video encoding apparatus 100 involving video prediction based on coding units according to a tree structure includes an LCU splitter 110, a coding unit determiner 120, and an output unit 130.

The LCU splitter 110 may split a current picture based on an LCU that is a coding unit having a maximum size for a current picture of an image. If the current picture is larger than the LCU, image data of the current picture may be split into the at least one LCU. The LCU according to an embodiment of the present invention may be a data unit having a size of 32×32, 64×64, 128×128, 256×256, etc., wherein a shape of the data unit is a square having a width and length in squares of 2.

A coding unit according to an embodiment may be characterized by a maximum size and a depth. The depth denotes the number of times the coding unit is spatially split from the LCU, and as the depth deepens, deeper coding units according to depths may be split from the LCU to a minimum coding unit. A depth of the LCU is an uppermost depth and a depth of the minimum coding unit is a lowermost depth. Since a size of a coding unit corresponding to each depth decreases as the depth of the LCU deepens, a coding unit corresponding to an upper depth may include a plurality of coding units corresponding to lower depths.

As described above, the image data of the current picture is split into the LCUs according to a maximum size of the coding unit, and each of the LCUs may include deeper coding units that are split according to depths. Since the LCU according to an embodiment of the present invention is split according to depths, the image data of a spatial domain included in the LCU may be hierarchically classified according to depths.

A maximum depth and a maximum size of a coding unit, which limit the total number of times a height and a width of the LCU are hierarchically split, may be predetermined.

The coding unit determiner 120 encodes at least one split region obtained by splitting a region of the LCU according to depths, and determines a depth to output a finally encoded image data according to the at least one split region. In other words, the coding unit determiner 120 determines a coded depth by encoding the image data in the deeper coding units according to depths, according to the LCU of the current picture, and selecting a depth having the least encoding error. The determined coded depth and the encoded image data according to the determined coded depth are output to the output unit 130.

The image data in the LCU is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one coded depth may be selected for each LCU.

The size of the LCU is split as a coding unit is hierarchically split according to depths, and as the number of coding units increases. Also, even if coding units correspond to the same depth in one LCU, it is determined whether to split each of the coding units corresponding to the same depth to a lower depth by measuring an encoding error of the image data of the each coding unit, separately. Accordingly, even when image data is included in one LCU, the encoding errors may differ according to regions in the one LCU, and thus the coded depths may differ according to regions in the image data. Thus, one or more coded depths may be determined in one LCU, and the image data of the LCU may be divided according to coding units of at least one coded depth.

Accordingly, the coding unit determiner 120 may determine coding units having a tree structure included in the LCU. The ‘coding units having a tree structure’ according to an embodiment of the present invention include coding units corresponding to a depth determined to be the coded depth, from among all deeper coding units included in the LCU. A coding unit of a coded depth may be hierarchically determined according to depths in the same region of the LCU, and may be independently determined in different regions. Similarly, a coded depth in a current region may be independently determined from a coded depth in another region.

A maximum depth according to an embodiment of the present invention is an index related to the number of splitting times from an LCU to a minimum coding unit. A first maximum depth according to an embodiment of the present invention may denote the total number of splitting times from the LCU to the minimum coding unit. A second maximum depth according to an embodiment of the present invention may denote the total number of depth levels from the LCU to the minimum coding unit. For example, when a depth of the LCU is 0, a depth of a coding unit, in which the LCU is split once, may be set to 1, and a depth of a coding unit, in which the LCU is split twice, may be set to 2. Here, if the minimum coding unit is a coding unit in which the LCU is split four times, 5 depth levels of depths 0, 1, 2, 3, and 4 exist, and thus the first maximum depth may be set to 4, and the second maximum depth may be set to 5.

Prediction encoding and transformation may be performed according to the LCU. The prediction encoding and the transformation are also performed based on the deeper coding units according to a depth equal to or depths less than the maximum depth, according to the LCU.

Since the number of deeper coding units increases whenever the LCU is split according to depths, encoding, including the prediction encoding and the transformation, is performed on all of the deeper coding units generated as the depth deepens. For convenience of description, the prediction encoding and the transformation will now be described based on a coding unit of a current depth, in an LCU.

The video encoding apparatus 100 may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the LCU, the prediction encoding may be performed based on a coding unit corresponding to a coded depth, i.e., based on a coding unit that is no longer split to coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit or a data unit obtained by splitting at least one of a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 may also perform the transformation on the image data in a coding unit based not only on the coding unit for encoding the image data, but also based on a data unit that is different from the coding unit. In order to perform the transformation in the coding unit, the transformation may be performed based on a data unit having a size smaller than or equal to the coding unit. For example, the data unit for the transformation may include a data unit for an intra mode and a data unit for an inter mode.

The transformation unit in the coding unit may be recursively split into smaller sized regions in the similar manner as the coding unit according to the tree structure. Thus, residual data in the coding unit may be divided according to the transformation unit having the tree structure according to transformation depths.

A transformation depth indicating the number of splitting times to reach the transformation unit by splitting the height and width of the coding unit may also be set in the transformation unit. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. In other words, the transformation unit having the tree structure may be set according to the transformation depths.

Encoding information according to coding units corresponding to a coded depth requires not only information about the coded depth, but also about information related to prediction encoding and transformation. Accordingly, the coding unit determiner 120 not only determines a coded depth having a least encoding error, but also determines a partition type in a prediction unit, a prediction mode according to prediction units, and a size of a transformation unit for transformation.

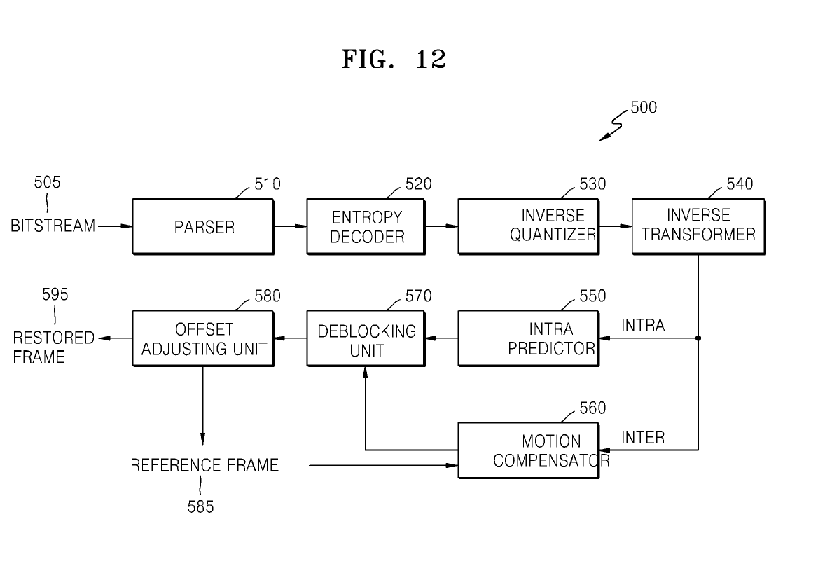

Coding units according to a tree structure in an LCU and methods of determining a prediction unit/partition, and a transformation unit, according to embodiments of the present invention, will be described in detail later with reference to FIGS. 10 through 20.

The coding unit determiner 120 may measure an encoding error of deeper coding units according to depths by using Rate-Distortion Optimization based on Lagrangian multipliers.

The output unit 130 outputs the image data of the LCU, which is encoded based on the at least one coded depth determined by the coding unit determiner 120, and information about the encoding mode according to the coded depth, in bitstreams.

The encoded image data may be obtained by encoding residual data of an image.

The information about the encoding mode according to coded depth may include information about the coded depth, about the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, image data in the current coding unit is encoded and output, and thus the split information may be defined not to split the current coding unit to a lower depth. Alternatively, if the current depth of the current coding unit is not the coded depth, the encoding is performed on the coding unit of the lower depth, and thus the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one LCU, and information about at least one encoding mode is determined for a coding unit of a coded depth, information about at least one encoding mode may be determined for one LCU. Also, a coded depth of the image data of the LCU may be different according to locations since the image data is hierarchically split according to depths, and thus information about the coded depth and the encoding mode may be set for the image data.

Accordingly, the output unit 130 may assign encoding information about a corresponding coded depth and an encoding mode to at least one of the coding unit, the prediction unit, and a minimum unit included in the LCU.

The minimum unit according to an embodiment of the present invention is a square data unit obtained by splitting the minimum coding unit constituting the lowermost depth by 4. Alternatively, the minimum unit according to an embodiment may be a maximum square data unit that may be included in all of the coding units, prediction units, partition units, and transformation units included in the LCU.

For example, the encoding information output by the output unit 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream, a sequence parameter set, or a picture parameter set.

Information about a maximum size of the transformation unit permitted with respect to a current video, and information about a minimum size of the transformation unit may also be output through a header of a bitstream, a sequence parameter set, or a picture parameter set. The output unit 130 may encode and output reference information related to prediction, prediction information, and slice type information.

In the video encoding apparatus 100, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit with the current depth having a size of 2N×2N may include a maximum of 4 of the coding units with the lower depth.

Accordingly, the video encoding apparatus 100 may form the coding units having the tree structure by determining coding units having an optimum shape and an optimum size for each LCU, based on the size of the LCU and the maximum depth determined considering characteristics of the current picture. Also, since encoding may be performed on each LCU by using any one of various prediction modes and transformations, an optimum encoding mode may be determined considering characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus 100, image compression efficiency may be increased since a coding unit is adjusted while considering characteristics of an image while increasing a maximum size of a coding unit while considering a size of the image.

The video encoding apparatus 100 determines coding units of a tree structure for every LCU, and generates symbols as a result of encoding performed for every encoding unit. The entropy encoding apparatus 10 may perform entropy encoding on symbols for every LCU. In particular, the entropy encoding apparatus 10 may perform entropy encoding on each LCU according to a row of LCUs including LCUs that are serially arranged in a horizontal direction, for every tile or slice segment generated by splitting a picture. Also, the entropy encoding apparatus 10 may simultaneously perform parallel entropy encoding on two or more rows of LCUs.

The first entropy encoder 12 sequentially performs entropy encoding on LCUs of a first row of LCUs which are serially arranged in a horizontal direction. Initial entropy coding probability information for an LCU that is to be first processed from among LCUs of the first row of LCUs may be determined as default probability information.

Entropy encoding may be performed on a second LCU of the first row of LCUs by using entropy coding probability information updated based on symbols of the foremost LCU of the first row of LCUs.

The second entropy encoder 14 may determine initial entropy coding probability information of a foremost LCU of a second row of LCUs as entropy coding probability information updated by an LCU of a fixed position of the first row of LCUs. The second entropy encoder 14 may perform entropy encoding on the foremost LCU of the second row of LCUs based on the initial entropy coding probability information. Beginning from the foremost LCU, the second entropy encoder 14 may sequentially perform entropy encoding on LCUs of the second row of LCUs which are serially arranged.

Likewise, after obtaining entropy coding probability information updated by a second LCU of the second row of LCUs, the entropy encoding apparatus 10 may start to perform entropy encoding on a third row of LCUs that are disposed under the second row of LCUs to be adjacent to the second row of LCUs.

After completing the entropy encoding to a last LCU of the first row of LCUs, the first entropy encoder 12 initializes internal state information of an entropy encoded bit string of the first row of LCUs. After completing the entropy encoding to a last LCU of the second row of LCUs, the second entropy encoder 14 may also initialize internal state information of an entropy encoded bit string of the second row of LCUs.

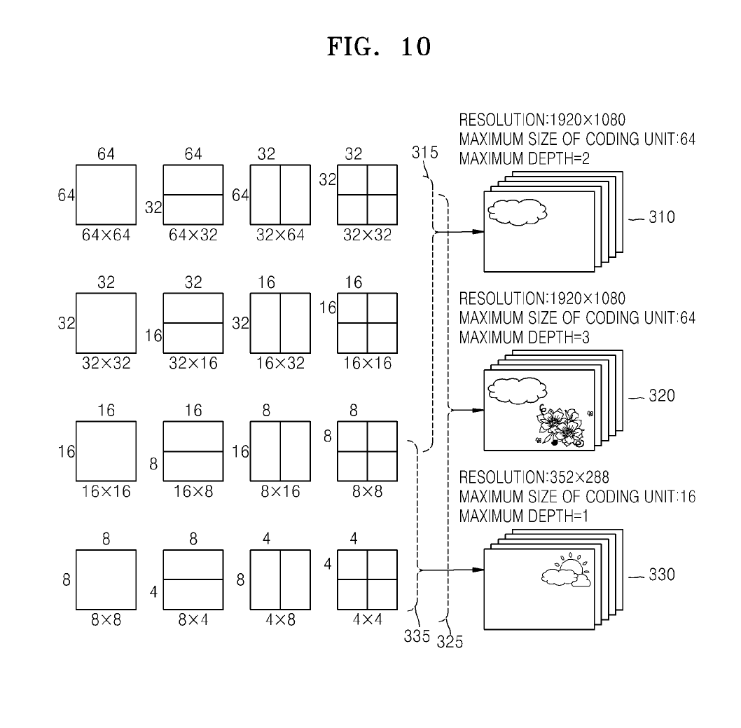

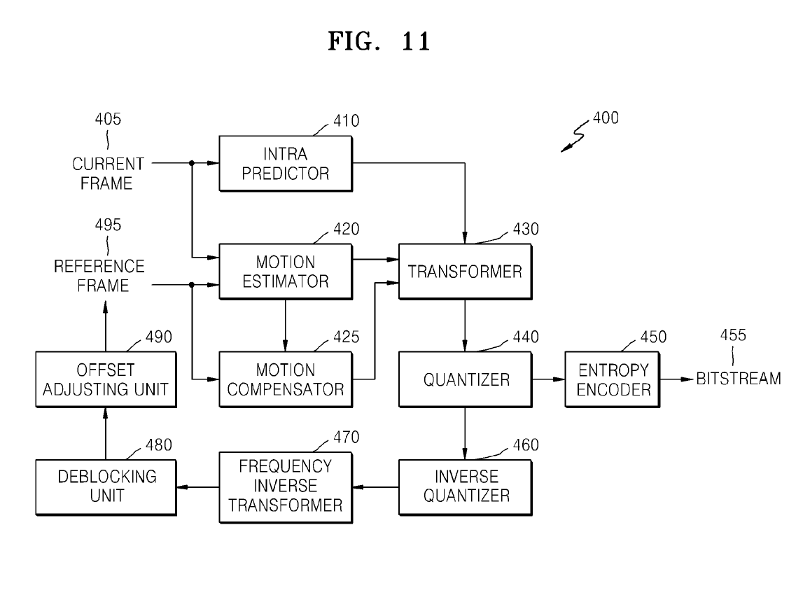

FIG. 9 is a block diagram of a video decoding apparatus 200 based on coding units having a tree structure, according to an embodiment of the present invention.

The video decoding apparatus 200 that involves video prediction based on coding units having a tree structure includes a receiver 210, an image data and encoding information extractor 220, and an image data decoder 230.

Definitions of various terms, such as a coding unit, a depth, a prediction unit, a transformation unit, and information about various encoding modes, for decoding operations of the video decoding apparatus 200 are identical to those described with reference to FIG. 8 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each LCU, and outputs the extracted image data to the image data decoder 230. The image data and encoding information extractor 220 may extract information about a maximum size of a coding unit of a current picture, from a header about the current picture, a sequence parameter set, or a picture parameter set.

Also, the image data and encoding information extractor 220 extracts information about a coded depth and an encoding mode for the coding units having a tree structure according to each LCU, from the parsed bitstream. The extracted information about the coded depth and the encoding mode is output to the image data decoder 230. In other words, the image data in a bit stream is split into the LCU so that the image data decoder 230 decodes the image data for each LCU.

The information about the coded depth and the encoding mode according to the LCU may be set for information about at least one coding unit corresponding to the coded depth, and information about an encoding mode may include information about a partition type of a corresponding coding unit corresponding to the coded depth, about a prediction mode, and a size of a transformation unit. Also, splitting information according to depths may be extracted as the information about the coded depth.

The information about the coded depth and the encoding mode according to each LCU extracted by the image data and encoding information extractor 220 is information about a coded depth and an encoding mode determined to generate a minimum encoding error when an encoder, such as the video encoding apparatus 100, repeatedly performs encoding for each deeper coding unit according to depths according to each LCU. Accordingly, the video decoding apparatus 200 may restore an image by decoding the image data according to a coded depth and an encoding mode that generates the minimum encoding error.

Since encoding information about the coded depth and the encoding mode may be assigned to a predetermined data unit from among a corresponding coding unit, a prediction unit, and a minimum unit, the image data and encoding information extractor 220 may extract the information about the coded depth and the encoding mode according to the predetermined data units. If information about a coded depth and encoding mode of a corresponding LCU is recorded according to predetermined data units, the predetermined data units to which the same information about the coded depth and the encoding mode is assigned may be inferred to be the data units included in the same LCU.

The image data decoder 230 restores the current picture by decoding the image data in each LCU based on the information about the coded depth and the encoding mode according to the LCUs. In other words, the image data decoder 230 may decode the encoded image data based on the extracted information about the partition type, the prediction mode, and the transformation unit for each coding unit from among the coding units having the tree structure included in each LCU. A decoding process may include a prediction including intra prediction and motion compensation, and an inverse transformation.

The image data decoder 230 may perform intra prediction or motion compensation according to a partition and a prediction mode of each coding unit, based on the information about the partition type and the prediction mode of the prediction unit of the coding unit according to coded depths.

In addition, the image data decoder 230 may read information about a transformation unit according to a tree structure for each coding unit so as to perform inverse transformation based on transformation units for each coding unit, for inverse transformation for each LCU. Via the inverse transformation, a pixel value of a spatial region of the coding unit may be restored.

The image data decoder 230 may determine a coded depth of a current LCU by using split information according to depths. If the split information indicates that image data is no longer split in the current depth, the current depth is a coded depth. Accordingly, the image data decoder 230 may decode encoded data in the current LCU by using the information about the partition type of the prediction unit, the prediction mode, and the size of the transformation unit for each coding unit corresponding to the coded depth.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. As such, the current coding unit may be decoded by obtaining the information about the encoding mode for each coding unit.

The receiver 210 may include the entropy decoding apparatus 20 of FIG. 2A. The entropy decoding apparatus 20 may parse a plurality of rows of LCUs from a received bitstream.

When the receiver 22 extracts a first row of LCUs and a second row of LCUs from the bitstream, the first entropy decoder 24 may sequentially restore symbols of LCUs of the first row of LCUs by performing entropy decoding on the first row of LCUs.

The second entropy decoder 26 may determine initial entropy coding probability information of a foremost LCU of the second row of LCUs as entropy coding probability information updated by an LCU of a fixed position of the first row of LCUs.

The second entropy decoder 26 may perform entropy decoding on the foremost LCU of the second row of LCUs based on the determined initial entropy coding probability information. The second entropy decoder 26 may perform entropy decoding on a second LCU based on a result of parsing the foremost LCU of the second row of LCUs. In this manner, LCU symbols of the second row of LCUs may be sequentially restored.

Likewise, after obtaining entropy coding probability information updated by the second LCU of the second row of LCUs, the entropy decoding apparatus 20 may start to perform entropy decoding on a third row of LCUs that are disposed under the second row of LCUs to be adjacent to the second row of LCUs.

After completing the entropy decoding to a last LCU of the first row of LCUs, the first entropy decoder 24 may initialize internal state information of a bit string of the first row of LCUs.

Accordingly, the entropy decoding apparatus 20 may restore symbols of LCUs by simultaneously performing parallel entropy decoding on two or more rows of LCUs.

Thus, the video decoding apparatus 200 may obtain information about at least one coding unit that generates the minimum encoding error when encoding is recursively performed for each LCU, and may use the information to decode the current picture. In other words, the coding units having the tree structure determined to be the optimum coding units in each LCU may be decoded.

Accordingly, even if image data has high resolution and a large amount of data, the image data may be efficiently decoded and restored by using a size of a coding unit and an encoding mode, which are adaptively determined according to characteristics of the image data, by using information about an optimum encoding mode received from an encoder.

FIG. 10 is a diagram for explaining a concept of coding units according to an embodiment of the present invention.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 10 denotes a total number of splits from an LCU to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the vide data 310 may include an LCU having a long axis size of 64, and coding units having long axis sizes of 32 and 16 since depths are deepened to two layers by splitting the LCU twice. Since the maximum depth of the video data 330 is 1, coding units 335 of the video data 330 may include an LCU having a long axis size of 16, and coding units having a long axis size of 8 since depths are deepened to one layer by splitting the LCU once.

Since the maximum depth of the video data 320 is 3, coding units 325 of the video data 320 may include an LCU having a long axis size of 64, and coding units having long axis sizes of 32, 16, and 8 since the depths are deepened to 3 layers by splitting the LCU three times. As a depth deepens, detailed information may be precisely expressed.

FIG. 11s a block diagram of an image encoder 400 based on coding units, according to an embodiment of the present invention.

The image encoder 400 performs operations of the coding unit determiner 120 of the video encoding apparatus 100 to encode image data. In other words, an intra predictor 410 performs intra prediction on coding units in an intra mode, from among a current frame 405, and a motion estimator 420 and a motion compensator 425 respectively perform inter estimation and motion compensation on coding units in an inter mode from among the current frame 405 by using the current frame 405, and a reference frame 495.

Data output from the intra predictor 410, the motion estimator 420, and the motion compensator 425 is output as a quantized transformation coefficient through a transformer 430 and a quantizer 440. The quantized transformation coefficient is restored as data in a spatial domain through an inverse quantizer 460 and an inverse transformer 470, and the restored data in the spatial domain is output as the reference frame 495 after being post-processed through a deblocking unit 480 and a loop filtering unit 490. The quantized transformation coefficient may be output as a bitstream 455 through an entropy encoder 450.

In order for the image encoder 400 to be applied in the video encoding apparatus 100, all elements of the image encoder 400, i.e., the intra predictor 410, the motion estimator 420, the motion compensator 425, the transformer 430, the quantizer 440, the entropy encoder 450, the inverse quantizer 460, the inverse transformer 470, the deblocking unit 480, and the loop filtering unit 490 perform operations based on each coding unit among coding units having a tree structure while considering the maximum depth of each LCU.

Specifically, the intra predictor 410, the motion estimator 420, and the motion compensator 425 determines partitions and a prediction mode of each coding unit from among the coding units having a tree structure while considering the maximum size and the maximum depth of a current LCU, and the transformer 430 determines the size of the transformation unit in each coding unit from among the coding units having a tree structure.

In particular, the entropy encoder 450 may correspond to the entropy encoding apparatus 10.

FIG. 12 is a block diagram of an image decoder 500 based on coding units, according to an embodiment of the present invention.

A parser 510 parses encoded image data to be decoded and information about encoding required for decoding from a bitstream 505. The encoded image data is output as inverse quantized data through an entropy decoder 520 and an inverse quantizer 530, and the inverse quantized data is restored to image data in a spatial domain through an inverse transformer 540.

An intra predictor 550 performs intra prediction on coding units in an intra mode with respect to the image data in the spatial domain, and a motion compensator 560 performs motion compensation on coding units in an inter mode by using a reference frame 585.

The image data in the spatial domain, which passed through the intra predictor 550 and the motion compensator 560, may be output as a restored frame 595 after being post-processed through a deblocking unit 570 and a loop filtering unit 580. Also, the image data that is post-processed through the deblocking unit 570 and the loop filtering unit 580 may be output as the reference frame 585.

In order to decode the image data in the image data decoder 230 of the video decoding apparatus 200, the image decoder 500 may perform operations that are performed after the parser 510.

In order for the image decoder 500 to be applied in the video decoding apparatus 200, all elements of the image decoder 500, i.e., the parser 510, the entropy decoder 520, the inverse quantizer 530, the inverse transformer 540, the intra predictor 550, the motion compensator 560, the deblocking unit 570, and the loop filtering unit 580 perform operations based on coding units having a tree structure for each LCU.

Specifically, the intra prediction 550 and the motion compensator 560 perform operations based on partitions and a prediction mode for each of the coding units having a tree structure, and the inverse transformer 540 perform operations based on a size of a transformation unit for each coding unit. In particular, the entropy decoder 520 may correspond to the entropy decoding apparatus 20.

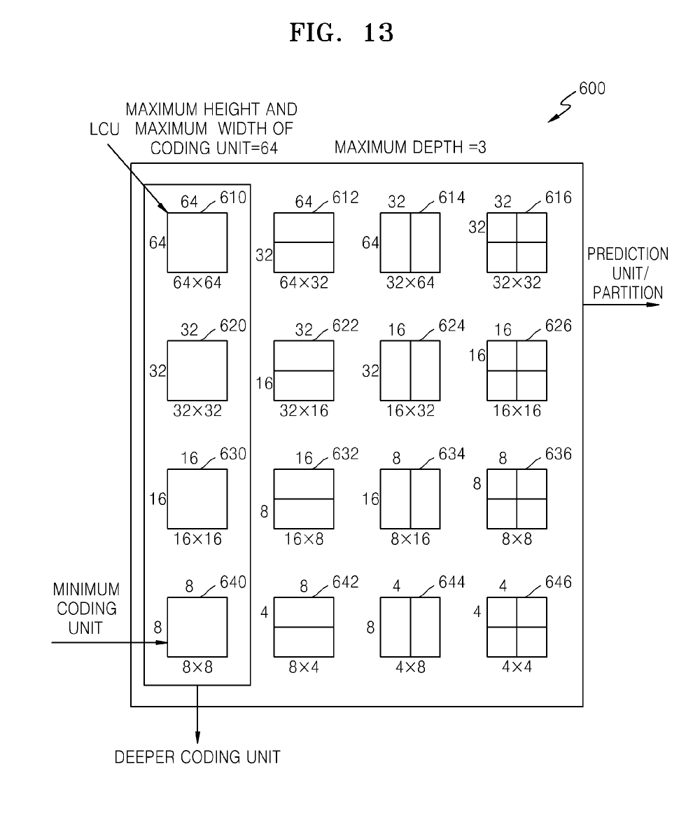

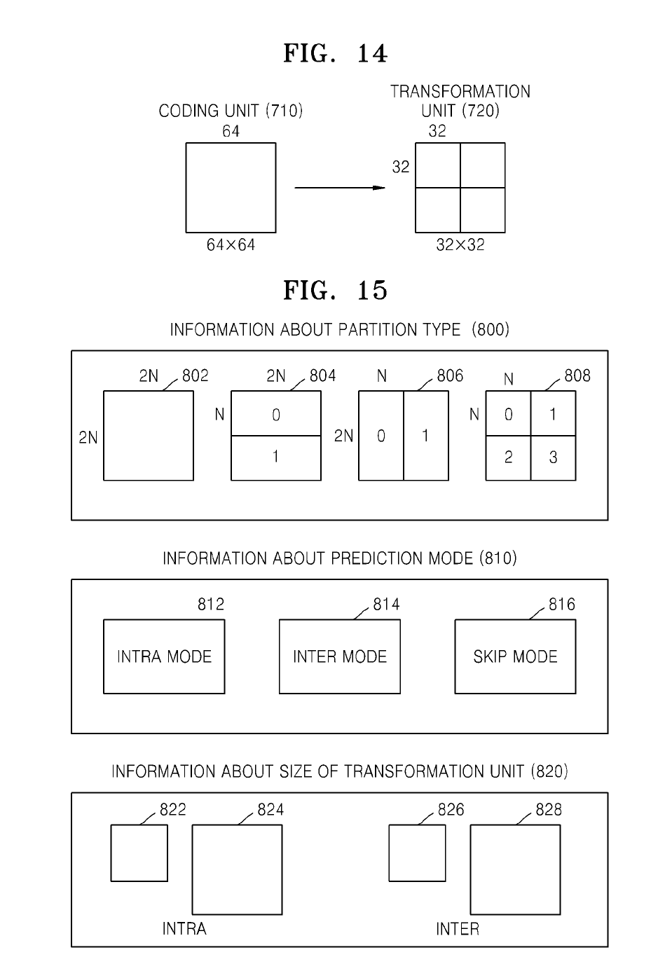

FIG. 13 is a diagram illustrating deeper coding units according to depths, and partitions, according to an embodiment of the present invention.

The video encoding apparatus 100 and the video decoding apparatus 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units, according to an embodiment of the present invention, the maximum height and the maximum width of the coding units are each 64, and the maximum depth is 4. In this case, the maximum depth refers to a total number of times the coding unit is split from the LCU to the minimum coding unit. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is an LCU in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having a size of 4×4 and a depth of 3 is a minimum coding unit.

The prediction unit and the partitions of a coding unit are arranged along the horizontal axis according to each depth. In other words, if the coding unit 610 having a size of 64×64 and a depth of 0 is a prediction unit, the prediction unit may be split into partitions include in the encoding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

In order to determine the at least one coded depth of the coding units constituting the LCU 610, the coding unit determiner 120 of the video encoding apparatus 100 performs encoding for coding units corresponding to each depth included in the LCU 610.

A number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens along the vertical axis of the hierarchical structure 600. A depth and a partition having the minimum encoding error in the coding unit 610 may be selected as the coded depth and a partition type of the coding unit 610.

FIG. 14 is a diagram for explaining a relationship between a coding unit 710 and transformation units 720, according to an embodiment of the present invention.

The video encoding apparatus 100 or the video decoding apparatus 200 encodes or decodes an image according to coding units having sizes smaller than or equal to an LCU for each LCU. Sizes of transformation units for transformation during encoding may be selected based on data units that are not larger than a corresponding coding unit.

For example, in the video encoding apparatus 100 or the video decoding apparatus 200, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

FIG. 15 is a diagram for describing encoding information of coding units corresponding to a coded depth, according to an embodiment of the present invention.

The output unit 130 of the video encoding apparatus 100 may encode and transmit information 800 about a partition type, information 810 about a prediction mode, and information 820 about a size of a transformation unit for each coding unit corresponding to a coded depth, as information about an encoding mode.

The information 800 indicates information about a shape of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 800, i.e., an intra mode 812, an inter mode 814, or a skip mode 816.

In particular, the video encoding apparatus 100 and the video decoding apparatus 200 may determine an intra mode type according to an intra prediction direction or a prediction type of a prediction unit of an intra mode 812.

According to intra prediction according to an intra mode type, a symbol of a current prediction unit may be determined by referring to a symbol of a neighboring prediction unit adjacent to the current prediction unit. Accordingly, information about a direction of the referred symbol may be represented as an intra mode type.

Examples of an intra mode type may include a planar mode type, a horizontal mode type, a vertical mode type, and a DC mode type. According to a planar mode type, pixel values of a current prediction unit are predicted as values with a gradation in a specific direction. According to a horizontal mode type, pixel values of a current prediction unit are predicted as neighboring pixel values located in a horizontal direction of the current prediction unit. According to a vertical mode type, pixel values of a current prediction unit are predicted as neighboring pixel values located in a vertical direction of the current prediction unit. According to a DC mode type, pixel values of a current prediction unit are predicted as DC values determined based on neighboring pixel values adjacent to the current prediction unit.

Also, an intra mode type may be represented as a value indicating a specific angle of a prediction direction. Also, an intra mode type of a prediction unit of a chroma component may be determined to be the same as an intra mode type of the same prediction unit of a luma component.

However, the video encoding apparatus 100 and the video decoding apparatus 200 may determine an intra mode type of a current prediction unit as a default mode type when a neighboring prediction unit of the current prediction unit is inaccessible data or is not a prediction unit of an intra mode.

A default mode type may be set to be one with a high occurrence probability from among intra mode types. In particular, a DC mode type or a planar mode type may be determined as a default mode type. However, when a default mode type is set as a specific type and then a type with a highest occurrence probability from among prediction units of an overall image is analyzed, an occurrence probability of the specific type set as the default mode type tends to be the highest.

Intra prediction according to a DC mode type has an advantage in that a prediction value is determined by using simple calculation. A planar mode type has an advantage in that image quality is improved. However, intra prediction according to a planar mode type requires too complex calculation compared to intra prediction according to a DC mode type. In particular, when compared with the amount of calculation of intra prediction according to a DC mode type, the amount of calculation of intra prediction according to a planar mode type increases as a size of a prediction unit increases. By contrast, in intra prediction according to a DC mode type, in a uniform area of an artificial image such as screen content, encoding efficiency of intra prediction may be greatly improved.

Accordingly, the video encoding apparatus 100 and the video decoding apparatus 200 may determine a DC mode type as a default mode type of an intra mode type. Accordingly, when an intra mode type is determined in order to perform intra prediction on a current prediction unit and a neighboring prediction unit of the current prediction unit is inaccessible data or is not a prediction unit of an intra mode, the video encoding apparatus 100 and the video decoding apparatus 200 may determine an intra mode type of the current prediction unit as a DC mode type which is a default mode type.

The information 820 indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 220 of the video decoding apparatus 200 may extract and use the information 800, 810, and 820 for decoding, according to each deeper coding unit.

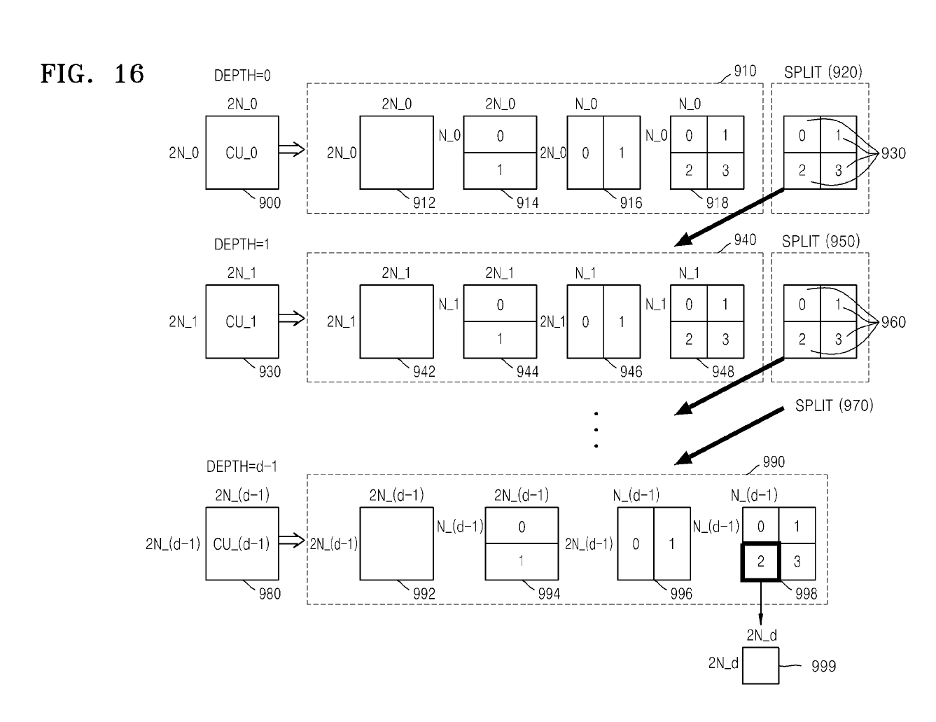

FIG. 16 is a diagram of deeper coding units according to depths, according to an embodiment of the present invention.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode is performed only on the partition having the size of 2N_{—}0×2N_{—}0.

If an encoding error is smallest in one of the partition types 912 through 916, the prediction unit 910 may not be split into a lower depth.

If the encoding error is the smallest in the partition type 918, a depth is changed from 0 to 1 to split the partition type 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948, a depth is changed from 1 to 2 to split the partition type 948 in operation 950, and encoding is repeatedly performed on coding units 960, which have a depth of 2 and a size of N_{—}2×N_{—}2 to search for a minimum encoding error.

When a maximum depth is d, split operation according to each depth may be performed up to when a depth becomes d−1, and split information may be encoded as up to when a depth is one of 0 to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition type 992 having a size of 2N_(d−1)×2N_(d−1), a partition type 994 having a size of 2N_(d−1)×N_(d−1), a partition type 996 having a size of N_(d−1)×2N_(d−1), and a partition type 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition types 992 through 998 to search for a partition type having a minimum encoding error.

Even when the partition type 998 has the minimum encoding error, since a maximum depth is d, a coding unit CU_(d−1) having a depth of d−1 is no longer split to a lower depth, and a coded depth for the coding units constituting a current LCU 900 is determined to be d−1 and a partition type of the current LCU 900 may be determined to be N_(d−1)×N_(d−1). Also, since the maximum depth is d and a minimum coding unit 980 having a lowermost depth of d−1 is no longer split to a lower depth, split information for the minimum coding unit 980 is not set.

A data unit 999 may be a ‘minimum unit’ for the current LCU. A minimum unit according to an embodiment of the present invention may be a square data unit obtained by splitting a minimum coding unit 980 by 4. By performing the encoding repeatedly, the video encoding apparatus 100 may select a depth having the least encoding error by comparing encoding errors according to depths of the coding unit 900 to determine a coded depth, and set a corresponding partition type and a prediction mode as an encoding mode of the coded depth.

As such, the minimum encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Also, since a coding unit is split from a depth of 0 to a coded depth, only split information of the coded depth is set to 0, and split information of depths excluding the coded depth is set to 1.

The image data and encoding information extractor 220 of the video decoding apparatus 200 may extract and use the information about the coded depth and the prediction unit of the coding unit 900 to decode the partition 912. The video decoding apparatus 200 may determine a depth, in which split information is 0, as a coded depth by using split information according to depths, and use information about an encoding mode of the corresponding depth for decoding.

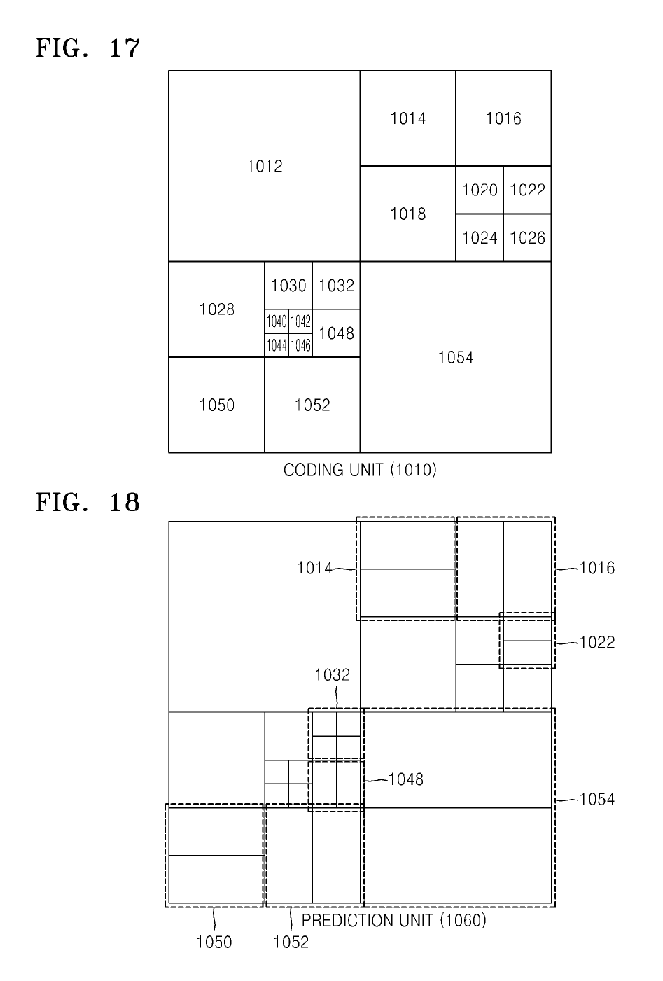

FIGS. 17 through 19 are diagrams for explaining a relationship between coding units 1010, prediction units 1060, and transformation units 1070, according to an embodiment of the present invention.

The coding units 1010 are coding units having a tree structure, corresponding to coded depths determined by the video encoding apparatus 100, in an LCU. The prediction units 1060 are partitions of prediction units of each of the coding units 1010, and the transformation units 1070 are transformation units of each of the coding units 1010.

When a depth of an LCU is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition types in the coding units 1014, 1022, 1050, and 1054 have a size of 2N×N, partition types in the coding units 1016, 1048, and 1052 have a size of N×2N, and a partition type of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are different from those in the prediction units 1060 in terms of sizes and shapes. In other words, the video encoding and decoding apparatuses 100 and 200 may perform intra prediction, motion estimation, motion compensation, transformation, and inverse transformation individually on a data unit in the same coding unit.

Accordingly, encoding is recursively performed on each of coding units having a hierarchical structure in each region of an LCU to determine an optimum coding unit, and thus coding units having a recursive tree structure may be obtained. Encoding information may include split information about a coding unit, information about a partition type, information about a prediction mode, and information about a size of a transformation unit. Table 1 shows the encoding information that may be set by the video encoding and decoding apparatuses 100 and 200.

TABLE 1

| Split Information 0 | | | | | Split |
|---|---|---|---|---|---|
| (Encoding on Coding Unit having Size of 2N × 2N and Current Depth of d) | | | | | Information 1 |
| Prediction | Partition Type | | Size of Transformation Unit | | Repeatedly |
| Mode | | | | | Encode |
| Intra | Symmetrical | Asymmetrical | Split | Split | Coding Units |
| Inter | Partition | Partition | Information 0 of | Information 1 of | having |
| Skip | Type | Type | Transformation | Transformation | Lower Depth |
| (Only | | | Unit | Unit | of d + 1 |
| 2N × 2N) | 2N × 2N | 2N × nU | 2N × 2N | N × N | |
| | 2N × N | 2N × nD | | (Symmetrical | |
| | N × 2N | nL × 2N | | Type) | |
| | N × N | nR × 2N | | N/2 × N/2 | |
| | | | | (Asymmetrical | |
| | | | | Type) | |

The output unit 130 of the video encoding apparatus 100 may output the encoding information about the coding units having a tree structure, and the image data and encoding information extractor 220 of the video decoding apparatus 200 may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a coded depth, and thus information about a partition type, prediction mode, and a size of a transformation unit may be defined for the coded depth. If the current coding unit is further split according to the split information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure may include at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth is determined by using encoding information of a data unit, and thus a distribution of coded depths in an LCU may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred for predicting the current coding unit.

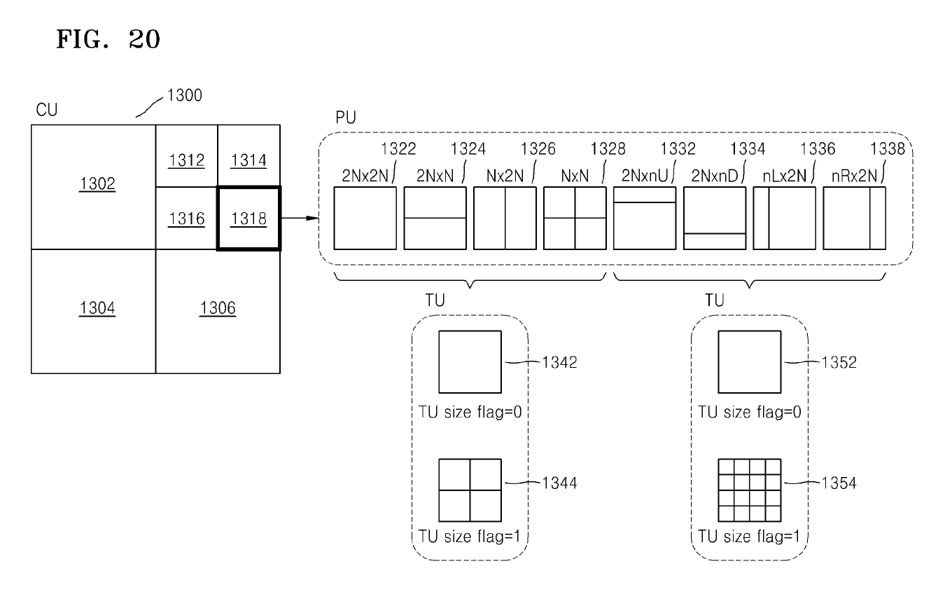

FIG. 20 is a diagram for explaining a relationship between a coding unit, a prediction unit, and a transformation unit, according to encoding mode information of Table 1.

An LCU 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

Split information (TU size flag) of a transformation unit is a type of a transformation index. The size of the transformation unit corresponding to the transformation index may be changed according to a prediction unit type or partition type of the coding unit.

For example, when the partition type is set to be symmetrical, i.e. the partition type 1322, 1324, 1326, or 1328, a transformation unit 1342 having a size of 2N×2N is set if a TU size flag of a transformation unit is 0, and a transformation unit 1344 having a size of N×N is set if a TU size flag is 1.

When the partition type is set to be asymmetrical, i.e., the partition type 1332, 1334, 1336, or 1338, a transformation unit 1352 having a size of 2N×2N is set if a TU size flag is 0, and a transformation unit 1354 having a size of N/2×N/2 is set if a TU size flag is 1.

Referring to FIG. 20, the TU size flag is a flag having a value or 0 or 1, but the TU size flag is not limited to 1 bit, and a transformation unit may be hierarchically split having a tree structure while the TU size flag increases from 0. Split information (TU size flag) of a transformation unit may be an example of a transformation index.

In this case, the size of a transformation unit that has been actually used may be expressed by using a TU size flag of a transformation unit, according to an embodiment according to the present invention, together with a maximum size and minimum size of the transformation unit. The video encoding apparatus 100 is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. The video decoding apparatus 200 may decode video by using the maximum transformation unit size information, the minimum transformation unit size information, and the maximum TU size flag.

For example, (a) if the size of a current coding unit is 64×64 and a maximum transformation unit size is 32×32, (a-1) then the size of a transformation unit may be 32×32 when a TU size flag is 0, (a-2) may be 16×16 when the TU size flag is 1, and (a-3) may be 8×8 when the TU size flag is 2.

As another example, (b) if the size of the current coding unit is 32×32 and a minimum transformation unit size is 32×32, (b-1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to an embodiment according to the present invention, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the present invention is not limited thereto.

According to the video encoding method based on coding units having a tree structure as described with reference to FIGS. 8 through 20, image data of a spatial region is encoded for each of coding units of a tree structure. According to the video decoding method based on coding units having a tree structure, decoding is performed for each LCU to restore image data of a spatial region. Thus, a picture and a video that is a picture sequence may be restored. The restored video may be reproduced by a reproducing apparatus, stored in a storage medium, or transmitted through a network.

The embodiments according to the present invention may be written as computer programs and may be implemented in general-use digital computers that execute the programs using a computer-readable recording medium. Examples of the computer-readable recording medium include magnetic storage media (e.g., ROM, floppy discs, hard discs, etc.) and optical recording media (e.g., CD-ROMs, or DVDs).

While the present invention has been particularly shown and described with reference to exemplary embodiments thereof, it will be understood by those of ordinary skill in the art that various changes in form and details may be made therein without departing from the spirit and scope according to the present invention as defined by the following claims.

For convenience of description, the inter prediction method and the video encoding method described with reference to FIGS. 1A through 20, will be collectively referred to as a ‘video encoding method according to the present invention’. In addition, the motion compensation method and the video decoding method described with reference to FIGS. 1A through 20, will be referred to as a ‘video decoding method according to the present invention’.

Also, a video encoding apparatus including the inter prediction apparatus 10, the video encoding apparatus 40, the video encoding apparatus 100, or the image encoder 400, which has been described with reference to FIGS. 1A through 20, will be referred to as a ‘video encoding apparatus according to the present invention’. In addition, a video decoding apparatus including the motion compensation apparatus 20, the video decoding apparatus 50, the video decoding apparatus 200, or the image decoder 500, which has been descried with reference to FIGS. 1A through 20, will be referred to as a ‘video decoding apparatus according to the present invention’.

A computer-readable recording medium storing a program, e.g., a disc 26000, according to an embodiment of the present invention will now be described in detail.

FIG. 21 is a diagram of a physical structure of the disc 26000 in which a program is stored, according to an embodiment of the present invention. The disc 26000, which is a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000, a program that executes the video encoding method and the video decoding method described above may be assigned and stored.

A computer system embodied using a storage medium that stores a program for executing the video encoding method and the video decoding method as described above will now be described with reference to FIG. 20.

FIG. 22 is a diagram of a disc drive 26800 for recording and reading a program by using the disc 26000. A computer system 27000 may store a program that executes at least one of a video encoding method and a video decoding method according to an embodiment of the present invention, in the disc 26000 via the disc drive 26800. To run the program stored in the disc 26000 in the computer system 27000, the program may be read from the disc 26000 and be transmitted to the computer system 26700 by using the disc drive 27000.

The program that executes at least one of a video encoding method and a video decoding method according to an embodiment of the present invention may be stored not only in the disc 26000 illustrated in FIG. 21 or 22 but also in a memory card, a ROM cassette, or a solid state drive (SSD).

A system to which the video encoding method and a video decoding method described above are applied will be described below.

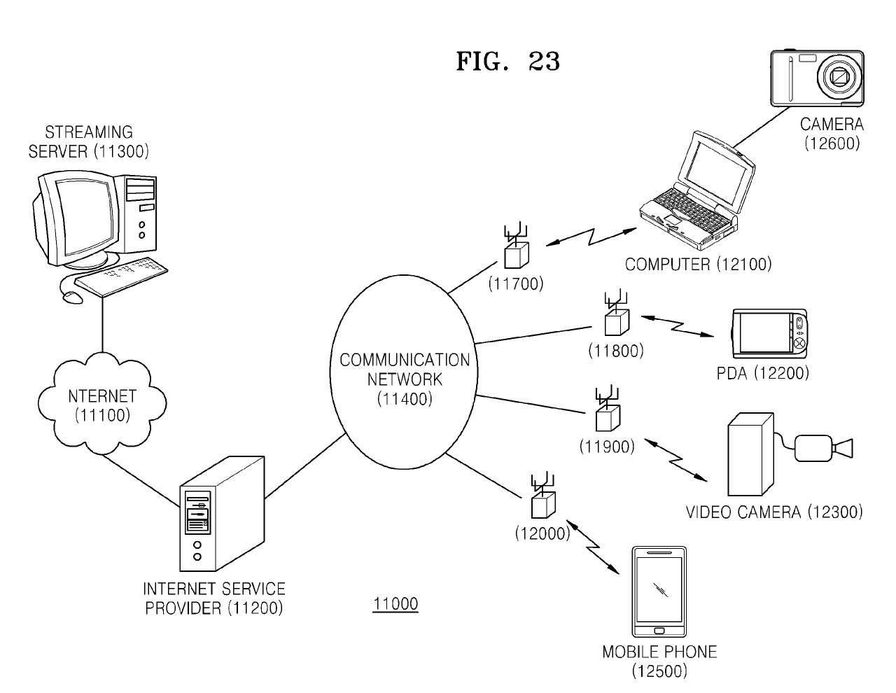

FIG. 23 is a diagram of an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

However, the content supply system 11000 is not limited to as illustrated in FIG. 21, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded using the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

The content supply system 11000 may encode content data recorded by a user using the video camera 12300, the camera 12600, the mobile phone 12500, or another imaging device, e.g., content recorded during a concert, and transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and decode and reproduce the encoded content data in real time, thereby enabling personal broadcasting.

Encoding and decoding operations of the plurality of independent devices included in the content supply system 11000 may be similar to those of a video encoding apparatus and a video decoding apparatus according to an embodiment of the present invention.

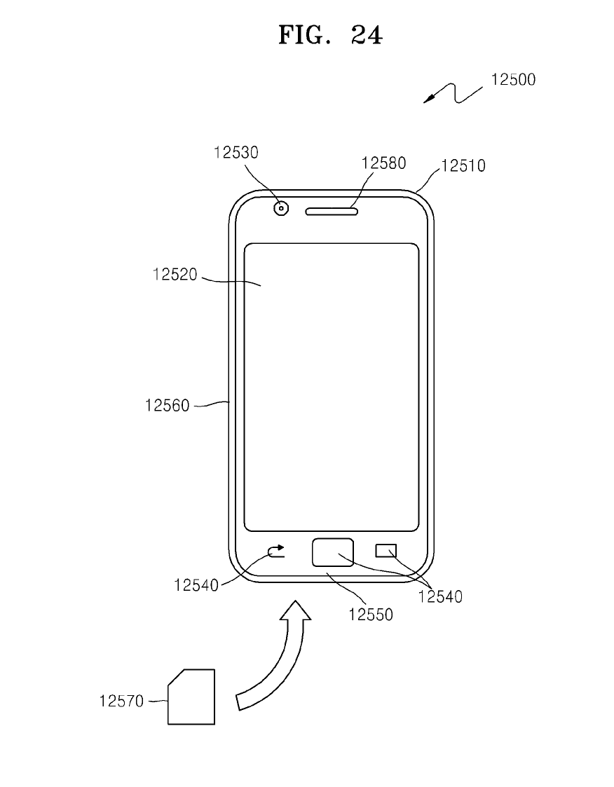

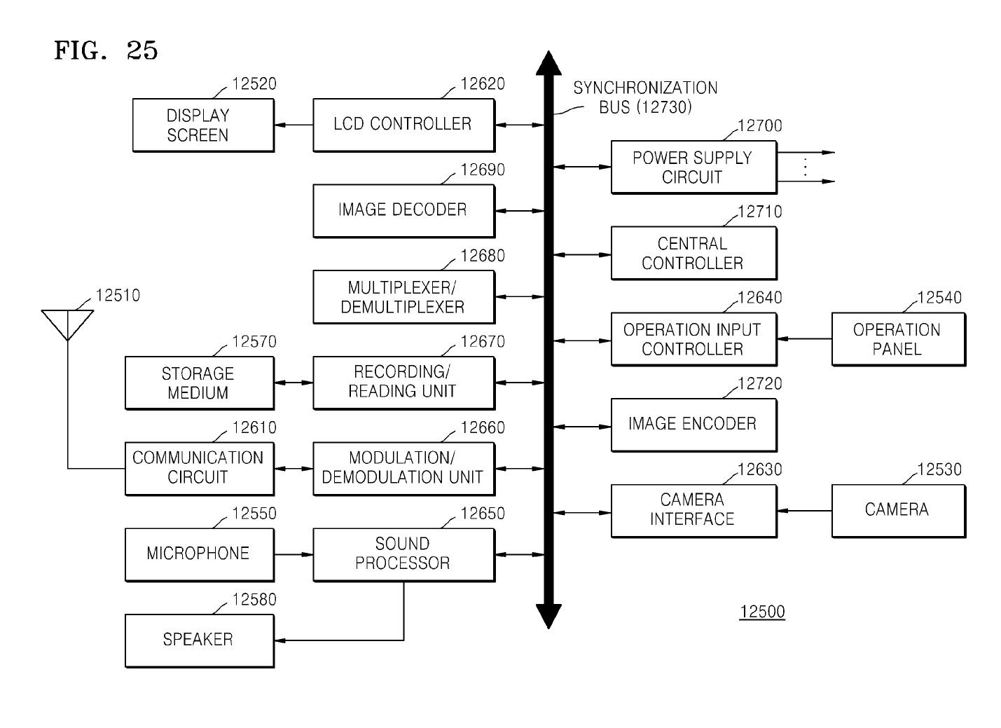

The mobile phone 12500 included in the content supply system 11000 according to an embodiment of the present invention will now be described in greater detail with referring to FIGS. 24 and 25.

FIG. 24 illustrates an external structure of the mobile phone 12500 to which a video encoding method and a video decoding method are applied, according to an embodiment of the present invention. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of sound output unit, and a microphone 12550 for inputting voice and sound or another type sound input unit. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 25 illustrates an internal structure of the mobile phone 12500, according to an embodiment of the present invention. To systemically control parts of the mobile phone 12500 including the display screen 12520 and the operation panel 12540, a power supply circuit 12700, an operation input controller 12640, an image encoding unit 12720, a camera interface 12630, an LCD controller 12620, an image decoding unit 12690, a multiplexer/demultiplexer 12680, a recording/reading unit 12670, a modulation/demodulation unit 12660, and a sound processor 12650 are connected to a central controller 12710 via a synchronization bus 12730.

If a user operates a power button and sets from a ‘power off’ state to a power on’ state, the power supply circuit 12700 supplies power to all the parts of the mobile phone 12500 from a battery pack, thereby setting the mobile phone 12500 in an operation mode.

The central controller 12710 includes a central processing unit (CPU), a ROM, and a RAM.

While the mobile phone 12500 transmits communication data to the outside, a digital signal is generated by the mobile phone 12500 under control of the central controller 12710. For example, the sound processor 12650 may generate a digital sound signal, the image encoding unit 12720 may generate a digital image signal, and text data of a message may be generated via the operation panel 12540 and the operation input controller 12640. When a digital signal is transmitted to the modulation/demodulation unit 12660 under control of the central controller 12710, the modulation/demodulation unit 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transformation signal via the modulation/demodulation unit 12660 and the communication circuit 12610, and may be transmitted via the antenna 12510.

When a text message, e.g., email, is transmitted in a data communication mode, text data of the text message is input via the operation panel 12540 and is transmitted to the central controller 12610 via the operation input controller 12640. Under control of the central controller 12610, the text data is transformed into a transmission signal via the modulation/demodulation unit 12660 and the communication circuit 12610 and is transmitted to the wireless base station 12000 via the antenna 12510.

To transmit image data in the data communication mode, image data captured by the camera 12530 is provided to the image encoding unit 12720 via the camera interface 12630. The captured image data may be directly displayed on the display screen 12520 via the camera interface 12630 and the LCD controller 12620.

A structure of the image encoding unit 12720 may correspond to that of the video encoding apparatus 100 described above. The image encoding unit 12720 may transform the image data received from the camera 12530 into compressed and encoded image data according to a video encoding method employed by the video encoding apparatus 100 or the image encoder 400 described above, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoding unit 12720, together with the sound data received from the sound processor 12650. A result of multiplexing the data may be transformed into a transmission signal via the modulation/demodulation unit 12660 and the communication circuit 12610, and may then be transmitted via the antenna 12510.

While the mobile phone 12500 receives communication data from the outside, frequency recovery and ADC are performed on a signal received via the antenna 12510 to transform the signal into a digital signal. The modulation/demodulation unit 12660 modulates a frequency band of the digital signal. The frequency-band modulated digital signal is transmitted to the video decoding unit 12690, the sound processor 12650, or the LCD controller 12620, according to the type of the digital signal.

In the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulation/demodulation unit 12660 and the sound processor 12650, and the analog sound signal is output via the speaker 12580, under control of the central controller 12710.

When in the data communication mode, data of a video file accessed at an Internet website is received, a signal received from the wireless base station 12000 via the antenna 12510 is output as multiplexed data via the modulation/demodulation unit 12660, and the multiplexed data is transmitted to the multiplexer/demultiplexer 12680.

To decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoding unit 12690 and the sound processor 12650, respectively.

A structure of the image decoding unit 12690 may correspond to that of the video decoding apparatus 200 described above. The image decoding unit 12690 may decode the encoded video data to obtain restored video data and provide the restored video data to the display screen 12520 via the LCD controller 12620, according to a video decoding method employed by the video decoding apparatus 200 or the image decoder 500 described above.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both a video encoding apparatus and a video decoding apparatus according to an embodiment of the present invention, may be a transceiving terminal including only the video encoding apparatus, or may be a transceiving terminal including only the video decoding apparatus.

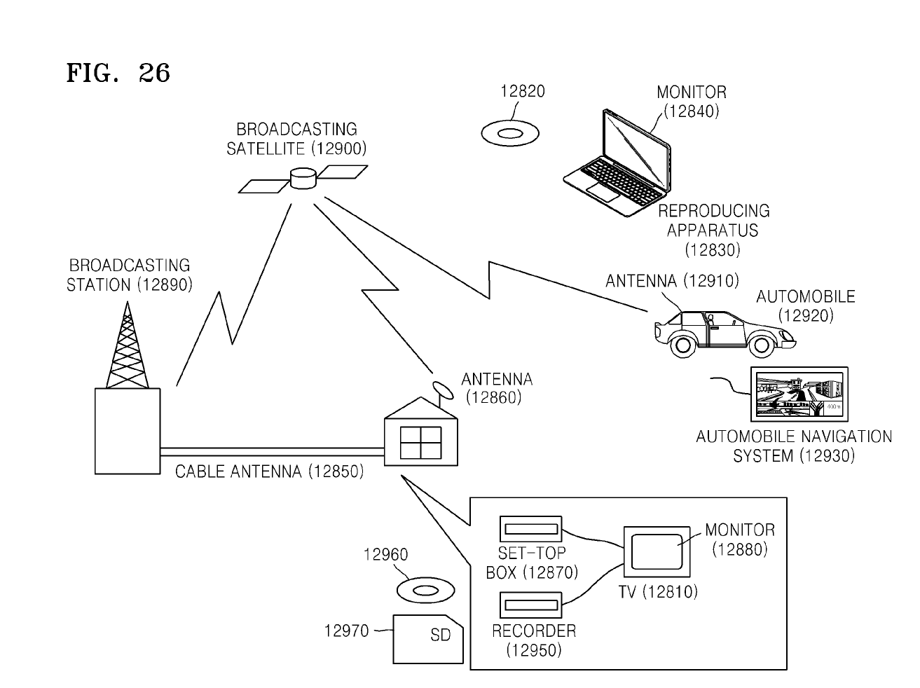

A communication system according to the present invention is not limited to the communication system described above with reference to FIG. 24. For example, FIG. 26 illustrates a digital broadcasting system employing a communication system, according to an embodiment of the present invention. The digital broadcasting system of FIG. 26 may receive a digital broadcast transmitted via a satellite or a terrestrial network by using a video encoding apparatus and a video decoding apparatus according to an embodiment of the present invention.

Specifically, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When a video decoding apparatus according to an embodiment of the present invention is implemented in a reproducing apparatus 12830, the reproducing apparatus 12830 may parse and decode an encoded video stream recorded on a storage medium 12820, such as a disc or a memory card to restore digital signals. Thus, the restored video signal may be reproduced, for example, on a monitor 12840.

In the set-top box 12870 connected to the antenna 12860 for a satellite/terrestrial broadcast or a cable antenna 12850 for receiving a cable television (TV) broadcast, a video decoding apparatus according to an embodiment of the present invention may be installed. Data output from the set-top box 12870 may also be reproduced on a TV monitor 12880.

As another example, a video decoding apparatus according to an embodiment of the present invention may be installed in the TV receiver 12810 instead of the set-top box 12870.

An automobile 12920 that has an appropriate antenna 12910 may receive a signal transmitted from the satellite 12900 or the wireless base station 11700. A decoded video may be reproduced on a display screen of an automobile navigation system 12930 installed in the automobile 12920.

A video signal may be encoded by a video encoding apparatus according to an embodiment of the present invention and may then be stored in a storage medium. Specifically, an image signal may be stored in a DVD disc 12960 by a DVD recorder or may be stored in a hard disc by a hard disc recorder 12950. As another example, the video signal may be stored in an SD card 12970. If the hard disc recorder 12950 includes a video decoding apparatus according to an embodiment of the present invention, a video signal recorded on the DVD disc 12960, the SD card 12970, or another storage medium may be reproduced on the TV monitor 12880.

The automobile navigation system 12930 may not include the camera 12530, the camera interface 12630, and the image encoding unit 12720 of FIG. 26. For example, the computer 12100 and the TV receiver 12810 may not be included in the camera 12530, the camera interface 12630, and the image encoding unit 12720 of FIG. 26.

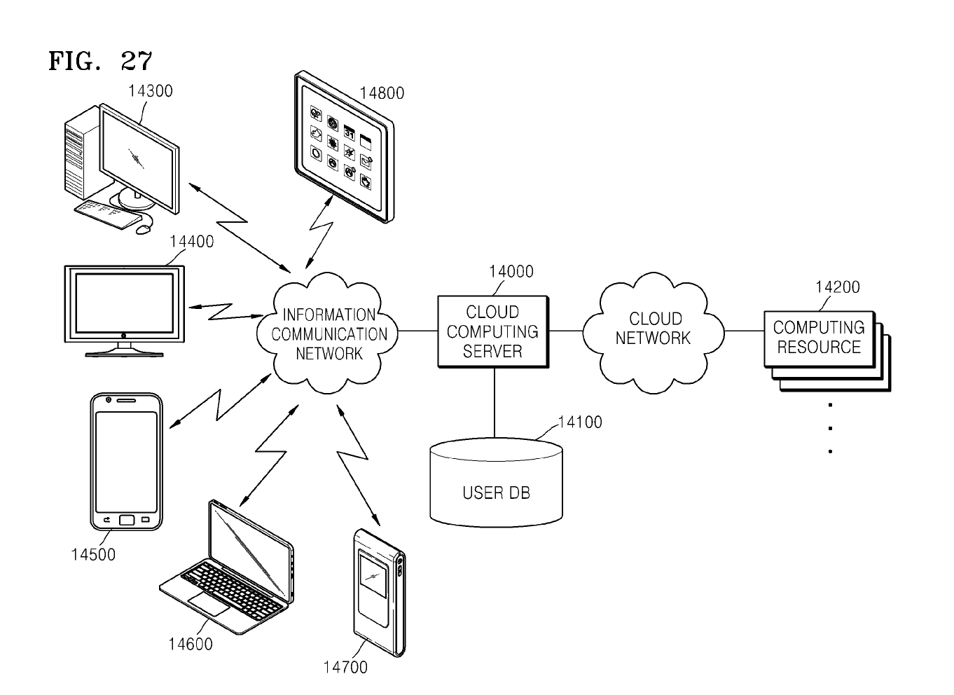

FIG. 27 is a diagram illustrating a network structure of a cloud computing system using a video encoding apparatus and a video decoding apparatus, according to an embodiment of the present invention.

The cloud computing system may include a cloud computing server 14000, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of combining. The plurality of computing resources 14200 may include various data services, and may include data uploaded from user terminals. As described above, the cloud computing server 14000 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce this video service is received from the smart phone 14500, the cloud computing server 14000 searches for and reproduces this video service, based on the user DB 14100. When the smart phone 14500 receives a video data stream from the cloud computing server 14000, a process of reproducing video by decoding the video data stream is similar to an operation of the mobile phone 12500 described above with reference to FIG. 24.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. If the user terminal requests to reproduce the video, starting from the pausing point thereof, the cloud computing server 14000 transmits streaming data of the video starting from a frame corresponding to the pausing point, to the user terminal.

In this case, the user terminal may include a video decoding apparatus as described above with reference to FIGS. 1A to 20. As another example, the user terminal may include a video encoding apparatus as described above with reference to FIGS. 1A to 20. Alternatively, the user terminal may include both the video decoding apparatus and the video encoding apparatus as described above with reference to FIGS. 1A to 20.

Various applications of a video encoding method, a video decoding method, a video encoding apparatus, and a video decoding apparatus according to embodiments of the present invention described above with reference to FIGS. 1A to 20 have been described above with reference to FIGS. 21 to 27. However, methods of storing the video encoding method and the video decoding method in a storage medium or methods of implementing the video encoding apparatus and the video decoding apparatus in a device, according to various embodiments of the present invention, are not limited to the embodiments described above with reference to FIGS. 21 to 27.

While the present invention has been particularly shown and described with reference to exemplary embodiments thereof by using specific terms, the embodiments and terms have merely been used to explain the present invention and should not be construed as limiting the scope of the present invention as defined by the claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

1. An entropy encoding method for video encoding, the entropy encoding method comprising:
sequentially performing entropy encoding on blocks of a first row of blocks which serially arranged in a horizontal direction from among blocks that each have a predetermined size and are obtained by splitting and encoding an image;
determining initial entropy coding probability information of a foremost block of a second row of blocks that are disposed under the first row of blocks to be adjacent to the first row of blocks as entropy coding probability information updated by a block of a fixed position of the first row of blocks, performing entropy encoding on the foremost block of the second row of blocks based on the determined initial entropy coding probability information, and sequentially performing entropy encoding on the serially arranged blocks of the second row of blocks; and
after the entropy encoding is completed to a last block of the first row of blocks, initializing internal state information of an entropy encoded bit string of the first row of blocks.

2. The entropy encoding method of claim 1, wherein the sequentially performing of the entropy encoding on the serially arranged blocks of the second row of blocks comprises:
in order to determine initial entropy coding probability information of the foremost block of the second row of blocks, referring to entropy coding probability information updated by a second block of the first row of blocks which is located at a right upper side of the foremost block of the second row of blocks,
wherein, in order to determine a block which is to be referred to in order to determine the initial entropy coding probability information of the foremost block of the second row of blocks, it is skipped to analyze about when context synchronization between the first row of blocks and the second row of blocks occurs in a picture comprising the image.

3. The entropy encoding method of claim 2, wherein the sequentially performing of the entropy encoding on the serially arranged blocks of the second row of blocks comprises, after obtaining entropy coding probability information updated based on symbols of the second block of the first row of blocks, starting to perform entropy encoding beginning from the foremost block of the second row of blocks,
wherein the entropy encoding method further comprises, after obtaining entropy encoding probability information updated by a second block of the second row of blocks, starting to perform entropy encoding on a third row of blocks that are disposed under the second row of blocks to be adjacent to the second row of blocks beginning from a foremost block of the third row of blocks.

4. The entropy encoding method of claim 1, wherein the initializing the internal state information of the entropy encoded bit string of the first row of blocks comprises:
in a buffer in which the entropy encoded bit string of the first row of blocks is stored, initializing to a default value offset information indicating a position where a code of the last block contacting a boundary of the image is stored and range information indicating a range of code intervals; and
performing entropy encoding based on the initialized internal state information on a fourth row of blocks that belong to the same thread as the first row of blocks and are processed subsequent to the first row of blocks,
wherein in order to initialize the internal state information, in the picture comprising the image, it is not allowed to select whether the internal state information of the entropy encoded bit string is initialized after entropy encoding performed on a last block for every row of blocks.

5. The entropy encoding method of claim 1, wherein the image is one of slice segments generated by splitting a picture in a horizontal direction or one of tiles generated by splitting the picture in horizontal and vertical directions, and
blocks of the image are largest coding units (LCUs) each comprising coding units of a tree structure, and each of the first row of blocks and the second row of blocks is a group of LCUs that are serially arranged in the horizontal direction.

6. An entropy decoding method for video decoding, the entropy decoding method comprising:
from a received bitstream, extracting a first row of blocks and a second row of blocks which each comprise a bit string of blocks serially arranged in a horizontal direction from among blocks that each have a predetermined size and are obtained by splitting and encoding an image;
sequentially restoring symbols of blocks of the first row of blocks by performing entropy decoding on the first row of blocks;
determining initial entropy coding probability information of a foremost block of the second row of blocks as entropy coding probability information updated by a block of a fixed position of the first row of blocks, performing entropy decoding on the foremost block of the second row of blocks based on the determined initial entropy coding probability information, and sequentially restoring symbols of blocks of the second row of blocks; and
after completing the entropy decoding performed to a last block of the first row of blocks, initializing internal state information of a bit string of the first row of blocks.

7. The entropy decoding method of claim 6, wherein the sequentially restoring of the symbols of the blocks of the second row of blocks comprises:
in order to determine initial entropy coding probability information of the foremost block of the second row of blocks, referring to entropy coding probability information updated by a second block of the first row of blocks which is located at a right upper side of the foremost block of the second row of blocks,
wherein, in order to determine a block which is to be referred to in order to determine the initial entropy coding probability information of the foremost block of the second row of blocks, information about when context synchronization between the first row of blocks and the second row of blocks occurs in a picture comprising the image is not parsed from the bitstream.

8. The entropy decoding method of claim 7, wherein the sequentially restoring of the symbols of the blocks of the second row of blocks comprises, after obtaining entropy coding probability information updated based on symbols of the second block of the first row of blocks, starting to perform entropy decoding beginning from the foremost block of the second row of blocks,
wherein the entropy decoding method further comprises, after obtaining entropy coding probability information updated by a second block of the second row of blocks, starting to perform entropy decoding on a third row of blocks that are disposed under the second row of blocks to be adjacent to the second row of blocks beginning from a foremost block of the third row of blocks.

9. The entropy decoding method of claim 6, wherein the initializing of the internal state information of the bit string of the first row of blocks comprises:
in a buffer in which the bit string of the first row of blocks is stored, initializing to a default value offset information indicating a position where a code of the last block contacting a boundary of the image is stored and range information indicating a range of code intervals; and
performing entropy decoding based on the initialized internal state information on a next bit string that belongs to the same thread as the first row of blocks and is processed subsequent to the bit string of the first row of blocks and restoring blocks of a fourth row of blocks,
wherein in order to initialize the internal state information, in a picture comprising the image, information about whether the internal state information is initialized is not parsed from the bitstream after entropy decoding performed on a last block for every row of blocks.

10. The entropy decoding method of claim 6, wherein the image is one of slice segments generated by splitting a picture in a horizontal direction or one of tiles generated by splitting the picture in horizontal and vertical directions, and
blocks of the image are LCUs each comprising coding units of a tree structure, and each of the first row of blocks and the second row of blocks is a group of LCUs that are serially arranged in the horizontal direction.

11. The entropy decoding method of claim 8, wherein when the entropy decoding method is performed by using two or more processing cores,
the sequentially restoring of the symbols of the blocks of the first row of blocks comprises, by using a first processing core, performing entropy decoding beginning from a second block of the first row of blocks by using entropy coding probability information updated based on symbols of a foremost block of the first row of blocks,
the sequentially restoring of the symbols of the blocks of the second row of blocks comprises, by using a second processing core, right after obtaining entropy coding probability information updated based on symbols of the second block of the first row of blocks, starting to perform entropy decoding on the second row of blocks beginning from the foremost block of the second row of blocks by using the obtained entropy coding probability information, and
an entropy decoding operation of the second processing core performed on the second row of blocks is delayed by as much as a time taken to obtain the entropy coding probability information updated based on the symbols of the second block of the first row of blocks from an entropy decoding operation of the first processing core performed on the first row of blocks.

12. The entropy decoding method of claim 6, wherein when the entropy decoding method is performed by using one processing core, the entropy decoding method comprises:
by using a first processing core, restoring symbols of the first row of blocks by sequentially performing entropy decoding on blocks of the first row of blocks by using a first processing core;
by using the first processing core, after the entropy decoding is completed to a last block of the first row of blocks, initializing internal state information of a bit string of the first row of blocks;
by using the first processing core, determining initial entropy coding probability information of the foremost block of the second row of blocks as entropy coding probability information updated by symbols of a second block of the first row of block, and sequentially restoring symbols of blocks of the second row of blocks by performing entropy decoding on the foremost block of the second row of blocks based on the determined initial entropy coding probability information;
by using the first processing core, after completing the entropy decoding to a last block of the second row of blocks, initializing internal state information of a bit string of the second row of blocks; and
by using the first processing core, determining initial entropy coding probability information of a foremost block of a third row of blocks that are disposed under the second row of blocks to be adjacent to the second row of blocks as entropy coding probability information updated by symbols of a second block of the second row of blocks, performing entropy decoding on the foremost block of the third row of blocks by using the initialized internal state information of the bit string of the first row of blocks and the determined initial entropy coding probability information, and sequentially restoring symbols of blocks of the third row of blocks.

13. An entropy encoding apparatus for video encoding, the entropy encoding apparatus comprising:
a first entropy encoder that sequentially performs entropy encoding on blocks of a first row of blocks which are serially arranged in a horizontal direction from among blocks that each have a predetermined size and are obtained by splitting and encoding an image; and
a second entropy encoder that determines initial entropy coding probability information of a foremost block of a second row of blocks which are disposed under the first row of blocks to be adjacent to the first row of blocks as entropy coding probability information updated by a block of a fixed position of the first row of blocks, performs entropy encoding on the foremost block of the second row of blocks based on the determined initial entropy coding probability information, and sequentially performs entropy encoding on blocks of the second row of blocks which are serially arranged,
wherein after the entropy encoding is completed to a last block of the first row of blocks, the first entropy encoder initializes internal state information of an entropy encoded bit string of the first row of blocks.

14. An entropy decoding apparatus for video decoding, the entropy decoding apparatus comprising:
a receiver that extracts, from a received bitstream, a first row of blocks and a second row of blocks each comprising a bit string of blocks serially arranged in a horizontal direction from among blocks that each have a predetermined size and are obtained by splitting and encoding an image;
a first entropy decoder that performs entropy decoding on the first row of blocks and sequentially restores symbols of blocks of the first row of blocks; and
a second entropy decoder that determines initial entropy coding probability information of a foremost block of the second row of blocks as entropy coding probability information updated by a block of a fixed position of the first row of blocks, performs entropy decoding on the foremost block of the second row of blocks based on the determined initial entropy coding probability information, and sequentially restores symbols of blocks of the second row of blocks,
wherein after the entropy decoding is completed to a last block of the first row of blocks, the first entropy decoder initializes internal state information of a bit string of the first row of blocks.

15. A non-transitory computer-readable recording medium for executing the method of any one of claims 1 through 6.
